(19) United States
(12) Patent Application Publication
(10) Pub. No.: US 2023/0306340 A1
(43) Pub. Date: Sep. 28, 2023

(54) OUTSOURCING MANAGEMENT APPARATUS, OUTSOURCING MANAGEMENT METHOD, AND RECORDING MEDIUM

(71) Applicant: Final Aim, Inc., Tokyo (JP)

(72) Inventors: Masafumi ASAKURA, Tokyo (JP); Yasuhide YOKOI, Tokyo (JP)

(21) Appl. No.: 18/023,235

(22) PCT Filed: Aug. 5, 2021
(86) PCT No.: PCT/JP2021/029125

§ 371 Date: Feb. 24, 2023

(30) Foreign Application Priority Data
Aug. 26, 2020 (JP) 2020-142217

(51) Int. Cl. G06Q 10/0635; G06Q 50/04

(52) U.S. Cl. CPC G06Q 10/0635; G06Q 50/04

(57) ABSTRACT

Conventionally, various problems may arise when manufacturing is outsourced and the outsourced manufacturing is undertaken. With an outsourcing management apparatus including: an outsourcing information reception unit that receives, from a first terminal, outsourcing information regarding outsourcing of manufacturing, in association with an outsourcer identifier that identifies an outsourcer that outsources manufacturing; an outsourcing information accumulation unit that accumulates the outsourcing information received by the outsourcing information reception unit; a risk information acquisition unit that inspects the outsourcing information to acquire risk information regarding the risk in the case of undertaking outsourced manufacturing corresponding to the outsourcing information; and a risk information transmission unit that transmits the risk information acquired by the risk information acquisition unit to a second terminal, it is possible to solve or alleviate various problems that may arise when manufacturing is outsourced and the outsourced manufacturing is undertaken.

### TECHNICAL FIELD

The present invention relates to an outsourcing management apparatus or the like that performs information processing using outsourcing information related to the outsourcing of manufacturing.

### BACKGROUND ART

According to conventional art, there is a technology for supporting the outsourcing of manufacturing to fabricators of parts (see Patent Document 1, for example).

According to Patent Document 1, the following operations are performed. The manufacturer that outsources the manufacturing transmits the drawing data of a part from a terminal to an apparatus. The apparatus analyzes the drawing data to determine the machinability of the part and calculates, for at least some of the one or more fabricators that can machine the part, the selling price of the part when sold by the fabricators. The apparatus further calculates the estimated price of the part, and transmits the price to the terminal. When the apparatus receives an order instruction from the terminal at the estimated price, the intermediary agent that provides the apparatus confirms the order. When the order is confirmed, the apparatus transmits an order confirmation for the part to at least some of the one or more fabricators that can machine the part. If the apparatus successfully receives an order notification, a manufacturing contractor is determined.

### CITATION LIST

Patent Document
Patent Document 1: JP 6462945B

### SUMMARY OF INVENTION

### Technical Problem

However, according to the prior art, it is possible to provide assistance in making contracts for the outsourcing of manufacturing, but various problems may arise when manufacturing is outsourced and the outsourced manufacturing is undertaken. Note that examples of the various problems include the occurrence of the risk of infringing a third party's right due to the manufacturing of the subject of the outsourcing of manufacturing, and the leakage of confidentiality due to improper disclosure of drawings or the like of the subject of the outsourcing of manufacturing.

### Solution to Problem

An outsourcing management apparatus according to a first aspect of the present invention is an outsourcing management apparatus including: an outsourcing information reception unit that receives, from a first terminal, outsourcing information regarding outsourcing of manufacturing, in association with an outsourcer identifier that identifies an outsourcer that outsources manufacturing; an outsourcing information accumulation unit that accumulates the outsourcing information received by the outsourcing information reception unit; a risk information acquisition unit that inspects the outsourcing information to acquire risk information regarding the risk in the case of undertaking outsourced manufacturing corresponding to the outsourcing information; and a risk information transmission unit that transmits the risk information acquired by the risk information acquisition unit to a second terminal.

With such a configuration, the outsourcee or the like can acquire information regarding the risk in the case of undertaking the outsourced manufacturing.

An outsourcing management apparatus according to a second aspect of the present invention is the outsourcing management apparatus according to the first aspect of the present invention, wherein the risk information acquisition unit inspects the outsourcing information to acquire risk information regarding the possibility of infringing a third party's design right when outsourcing of manufacturing corresponding to the outsourcing information is to be undertaken.

With such a configuration, the outsourcee or the like can acquire information regarding the risk of infringing a design right in the case of undertaking the outsourced manufacturing.

An outsourcing management apparatus according to a third aspect of the present invention is the outsourcing management apparatus according to the second aspect of the present invention, wherein the outsourcing information includes design right information regarding a design right owned by the outsourcer, designer information regarding a designer who designed a subject of the outsourcing of manufacturing, and the risk information acquisition unit inspects the outsourcing information, and if the risk information acquisition unit judges that the design right information included in the outsourcing information is information indicating that the outsourcer owns a design right for the subject of the outsourcing of manufacturing, or if the risk information acquisition unit judges that outsourcing information includes designer information, the risk information acquisition unit acquires risk information indicating a risk level that is low enough to satisfy a predetermined condition.

With such a configuration, the outsourcee or the like can acquire appropriate information regarding the risk of infringing a design right in the case of undertaking the outsourced manufacturing.

An outsourcing management apparatus according to a fourth aspect of the present invention is the outsourcing management apparatus according to any one of the first to third aspects of the present invention, wherein the outsourcing information includes agreement information regarding an outsourcing agreement, the agreement information can include first liability avoidance information indicating that the outsourcer is liable if the subject of the outsourcing of manufacturing infringes a third party's right, and if the agreement information included in the outsourcing information includes the first liability avoidance information, the risk information acquisition unit acquires risk information indicating a risk level that is low enough to satisfy a predetermined condition.

With such a configuration, the outsourcee or the like can acquire information regarding the risk of infringing a third party's right in the case of undertaking the outsourced manufacturing.

An outsourcing management apparatus according to a fifth aspect of the present invention is the outsourcing management apparatus according to the fourth aspect of the present invention, wherein the risk information acquisition unit includes: a first liability judgment part that inspects the agreement information included in the outsourcing information to judge whether or not the agreement information includes the first liability avoidance information; and a risk information acquisition part that, if the first liability judgment part judges that the agreement information includes the first liability avoidance information, acquires risk information indicating a risk level that is low enough to satisfy a predetermined condition.

With such a configuration, the outsourcee or the like can acquire appropriate information regarding the risk of infringing a third party's right in the case of undertaking the outsourced manufacturing.

An outsourcing management apparatus according to a sixth aspect of the present invention is the outsourcing management apparatus according to the fourth aspect of the present invention, wherein subcontract agreement information that is information regarding an agreement corresponding to the outsourcing information and is information regarding a subcontract agreement between the outsourcee and a subcontractor is associated with the outsourcing information, the subcontract agreement information can include second liability avoidance information indicating that the outsourcee is liable if infringement of a third party's right occurs, and the risk information acquisition unit includes: a second liability judgment part that inspects the subcontract agreement information corresponding to the outsourcing information to judge whether or not the subcontract agreement information includes the second liability avoidance information; and a risk information acquisition part that, if the second liability judgment part judges that the subcontract agreement information includes the second liability avoidance information, acquires risk information that is risk information for the subcontractor and indicates a risk level that is low enough to satisfy a predetermined condition.

With such a configuration, it is possible to provide appropriate risk information to the subcontractor.

An outsourcing management apparatus according to a seventh aspect of the present invention is the outsourcing management apparatus according to any one of the first to sixth aspects of the present invention, wherein the outsourcing information includes two or more pieces of partial outsourcing information each constituting a part of the outsourcing information, one or more pieces of partial outsourcing information of the two or more pieces of partial outsourcing information are associated with specification information that specifies a subject of the outsourcing of manufacturing, and the outsourcing management apparatus further includes: an instruction reception unit that receives, in association with an outsourcee identifier that identifies an outsourcee that is a user, or a subcontractor identifier that identifies a subcontractor that is a user, an outsourcing information transmission instruction that is an instruction to transmit outsourcing information, from a second terminal of the outsourcee or a third terminal of the subcontractor; a determination unit that determines one or more pieces of partial outsourcing information corresponding to the subject of the outsourcing of manufacturing to the user identified by the outsourcee identifier or the subcontractor identifier corresponding to the outsourcing information transmission instruction received by the instruction reception unit, using specification information that is associated with the one or more pieces of partial outsourcing information; and an outsourcing information transmission unit that transmits the one or more pieces of partial outsourcing information determined by the determination unit, to the second terminal or the third terminal.

With such a configuration, it is possible to protect the interests of the outsourcer by disclosing only necessary information for the outsourcee to the outsourcee.

An outsourcing management apparatus according to an eighth aspect of the present invention is the outsourcing management apparatus according to the seventh aspect of the present invention, wherein the specification information includes a subject identifier that identifies the subject of the outsourcing of manufacturing, the outsourcing information includes agreement information regarding an outsourcing agreement, and the determination unit includes: a subject identifier acquisition part that inspects the agreement information to acquire the subject identifier; and a determination part that determines one or more pieces of partial outsourcing information that include one or more pieces of partial outsourcing information that are paired with the subject identifier acquired by the subject identifier acquisition part.

With such a configuration, it is possible to appropriately protect the interests of the outsourcer by disclosing only necessary information for the outsourcee to the outsourcee.

An outsourcing management apparatus according to a ninth aspect of the present invention is the outsourcing management apparatus according to the seventh or the eighth aspect of the present invention, further including an outsourcee information storage unit stores one or more pieces of outsourcee information that each include an outsourcee identifier that identifies an outsourcee, and a trust score that indicates a degree of trustworthiness of the outsourcee, or one or more pieces of subcontractor information that each include a subcontractor identifier that identifies a subcontractor, and a trust score that indicates a degree of trustworthiness of the subcontractor, wherein the determination unit uses the trust score that is paired with the outsourcee identifier or the subcontractor identifier, to determine the one or more pieces of partial outsourcing information.

With such a configuration, it is possible to disclose appropriate information depending on the trust score of the outsourcee or the subcontractor.

An outsourcing management apparatus according to a tenth aspect of the present invention is the outsourcing management apparatus according to any one of the seventh to ninth aspects of the present invention, further including a permission information reception unit that receives, from the first terminal, permission information indicating that the one or more pieces of partial outsourcing information determined by the determination unit is permitted to be transmitted to the second terminal or the third terminal, wherein the outsourcing information transmission unit transmits only one or more pieces of partial outsourcing information corresponding to the permission information received by the permission information reception unit, to the second terminal.

With such a configuration, when information is to be disclosed to the outsourcee, it is possible to protect the interests of the outsourcer more reliably by providing a mechanism that necessitates the permission of the outsourcer.

An outsourcing management apparatus according to an eleventh aspect of the present invention is the outsourcing management apparatus according to any one of the first to tenth aspects of the present invention, further including: a tampering inspection unit that inspects for tampering with the outsourcing information received by the outsourcing information reception unit; and a tampering information output unit that outputs tampering information regarding tampering if the result of the inspection by the tampering inspection unit indicates that the outsourcing information has been tampered with.

With such a configuration, it is possible to inspect for tampering with the outsourcing information transmitted by the outsourcer. Therefore, it is easier for the outsourcee to judge whether or not to undertake the outsourced manufacturing.

An outsourcing management apparatus according to a twelfth aspect of the present invention is the outsourcing management apparatus according to any one of the first to eleventh aspects of the present invention, the outsourcing information includes agreement information regarding an outsourcing agreement, and the outsourcing management apparatus further includes a subcontract prohibition processing unit that judges whether or not subcontract prohibition information that prohibits a subcontract is included in the agreement information, and if the subcontract prohibition processing unit judges that the subcontract prohibition information is included therein, the subcontract prohibition processing unit performs subcontract prohibition processing to prohibit a subcontract.

With such a configuration, it is possible to detect prohibition of a subcontract and perform appropriate processing.

### Advantageous Effects of Invention

With the outsourcing management device according to the present invention, it is possible to solve or alleviate various problems that may arise when manufacturing is outsourced and the outsourced manufacturing is undertaken.

### BRIEF DESCRIPTION OF DRAWINGS

FIG. 1 is a conceptual diagram for an outsourcing management system A according to a first embodiment.

FIG. 2 is a block diagram for the outsourcing management system A.

FIG. 3 is a block diagram for an outsourcing management apparatus 1 according to the same.

FIG. 4 is a flowchart illustrating examples of operations of the outsourcing management apparatus 1.

FIG. 5 is a flowchart illustrating an example of tampering inspection processing according to the same.

FIG. 6 is a flowchart illustrating an example of determination processing according to the same.

FIG. 7 is a flowchart illustrating an example of permission acquisition processing according to the same.

FIG. 8 is a flowchart illustrating an example of risk information acquisition processing according to the same.

FIG. 9 is a flowchart illustrating an example of design right judgment processing according to the same.

FIG. 10 is a flowchart illustrating an example of designer judgment processing according to the same.

FIG. 11 is a flowchart illustrating an example of first liability judgment processing according to the same.

FIG. 12 is a flowchart illustrating an example of second liability judgment processing according to the same.

FIG. 13 is a flowchart illustrating an example of risk information forming processing according to the same.

FIG. 14 is a flowchart illustrating an example of subcontract prohibition judgment processing according to the same.

FIG. 15 is a flowchart illustrating examples of operations of a first terminal 2 according to the same.

FIG. 16 is a flowchart illustrating examples of operations of a second terminal 3 according to the same.

FIG. 17 is a flowchart illustrating examples of operations of a third terminal 4 according to the same. same.

FIG. 18 is an overview diagram for a computer system according to the

FIG. 19 is a block diagram for the computer system.

### DESCRIPTION OF EMBODIMENT

Hereinafter, an embodiment of an outsourcing management apparatus or the like will be described with reference to the drawings. The components with the same reference numerals in the embodiment perform the same operations, and therefore the redundant descriptions thereof may be omitted.

### First Embodiment

The present embodiment describes an outsourcing management system that includes an outsourcing management apparatus that receives outsourcing information regarding the outsourcing of manufacturing from an outsourcer, and accumulates the outsourcing information. Note that examples of the outsourcing of manufacturing include the outsourcing of manufacturing that involves the use of a 3D printer, the outsourcing of manufacturing for manual product prototyping, the outsourcing of manufacturing for mass production that involves the use of molds, and so on, and there is no limitation on the subject, type, or the like of the outsourcing.

The present embodiment also describes an outsourcing management system that includes an outsourcing management apparatus that acquires risk information regarding the risk in the case of undertaking the outsourced manufacturing and transmits the risk information. Note that risk information includes, for example, information regarding the risk of infringing a third party's design right, information indicating that the outsourcer owns the design right, and information indicating that there is information regarding the designer who designed the subject of the outsourcing of manufacturing.

The present embodiment also describes an outsourcing management apparatus that acquires risk information indicating that the risk is low if outsourcing information includes information indicating that the outsourcer is liable for infringement of a third party's right.

The present embodiment also describes an outsourcing management system that includes an outsourcing apparatus that provides a subcontractor with risk information indicating a lower risk if the contract between the outsourcee and the subcontractor is such that the outsourcee is liable for infringement of a third party's right.

The present embodiment also describes an outsourcing management system that includes an outsourcing management apparatus that automatically determines the information to be disclosed to the outsourcee or the subcontractor. Note that the information to be disclosed is determined based on the results of analysis of the contents of the agreement, and the trust score of the outsourcee or the subcontractor, for example.

The present embodiment also describes an outsourcing management system that includes an outsourcing management apparatus that is provided with a mechanism for enabling the outsourcer to permit or prohibit the disclosure of information before the information is disclosed.

The present embodiment also describes an outsourcing management system that includes an outsourcing management apparatus that can inspect for tampering with uploaded information such as outsourcing information.

Furthermore, the present embodiment describes an outsourcing management system that includes an outsourcing management apparatus that determines whether or not the agreement includes a clause prohibiting a subcontract, and performs processing to prevent a subcontract if the contract includes a clause prohibiting a subcontract.

Note that outsourcing information includes, for example, a quotation, an outsourcing agreement, a design publication, design data such as photographs showing the external appearance of the product, parts drawings, assembly drawings, and so on of the parts that are to be outsourced, and designer information.

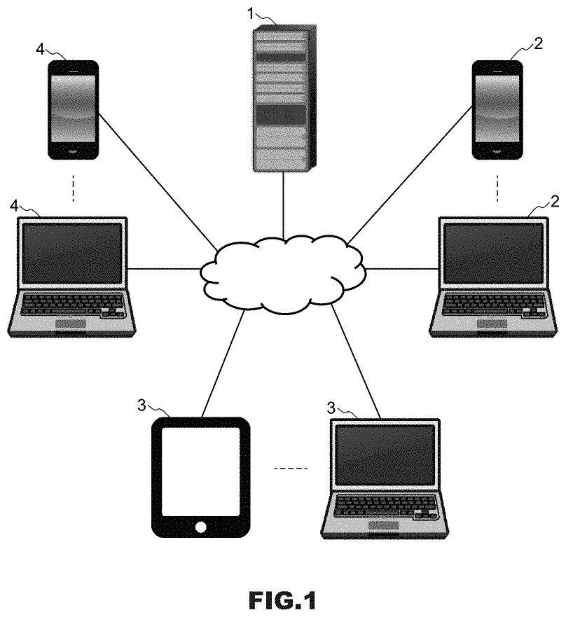

FIG. 1 is a conceptual diagram for an outsourcing management system A according to the present embodiment. The outsourcing management system A includes, for example, an outsourcing management apparatus 1, one or more first terminals 2, one or more second terminals 3, and one or more third terminals 4. The outsourcing management system A does not necessarily have to include the third terminals 4.

The outsourcing management apparatus 1 is a server that receives and manages outsourcing information, which will be described later. Examples of the outsourcing management apparatus 1 include a cloud server and an ASP server, but there is no limitation on the type thereof.

Each first terminal 2 is a terminal used by an outsourcer that outsources manufacturing. Each second terminal 3 is a terminal used by an outsourcee that undertakes the outsourced manufacturing. Each third terminal 4 is a terminal for a subcontractor to which manufacturing is re-outsourced from the outsourcer.

The first terminals 2, the second terminals 3, and the third terminals 4 are, for example, mobile terminals such as smartphones, tablet terminals, or mobile phones, or so-called personal computers, and there is no limitation on the types thereof.

The outsourcing management apparatus 1 can communicate with the first terminals 2, the second terminals 3, and the third terminals 4 via a network such as the Internet.

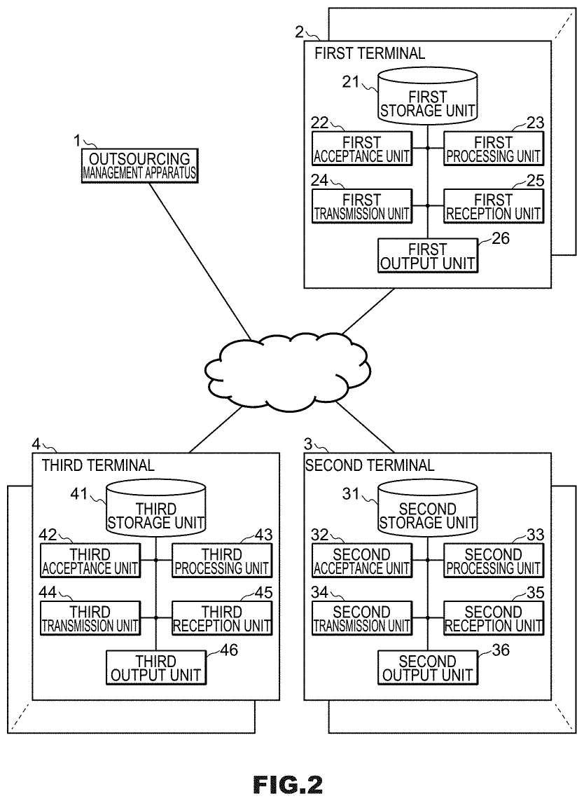

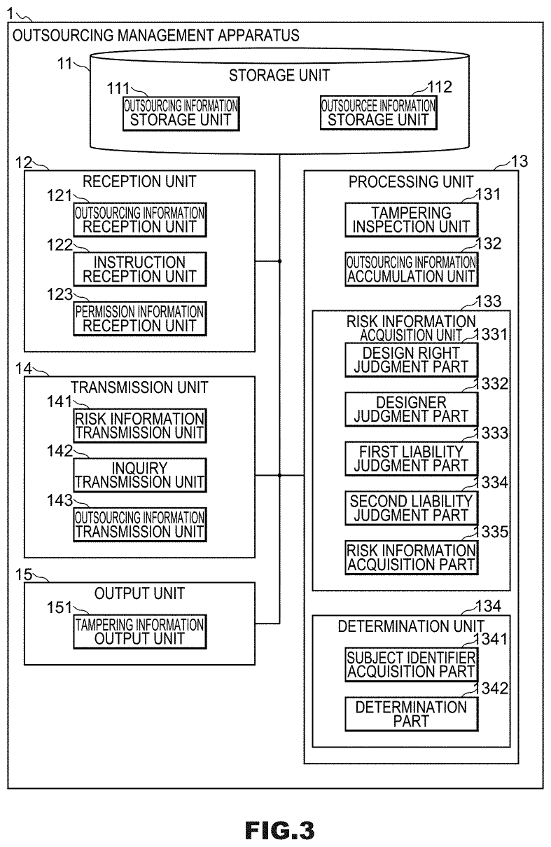

FIG. 2 is a block diagram for the outsourcing management system A according to the present embodiment. FIG. 3 is a block diagram for the outsourcing management apparatus 1.

The outsourcing management apparatus 1 included in the outsourcing management system A includes a storage unit 11, a reception unit 12, a processing unit 13, a transmission unit 14, and an output unit 15. The storage unit 11 includes an outsourcing information storage unit 111 and an outsourcee information storage unit 112. The reception unit 12 includes an outsourcing information reception unit 121, an instruction reception unit 122, and a permission information reception unit 123. The processing unit 13 includes a tampering inspection unit 131, an outsourcing information accumulation unit 132, a risk information acquisition unit 133, a determination unit 134, and a subcontract prohibition processing unit 135. The risk information acquisition unit 133 includes a design right judgment part 1331, a designer judgment part 1332, a first liability judgment part 1333, a second liability judgment part 1334, and a risk information acquisition part 1335. The determination unit 134 includes a subject identifier acquisition part 1341 and a determination part 1342. The subcontract prohibition processing unit 135 includes a subcontract prohibition judgment part 1351 and a subcontract prohibition processing part 1352. The transmission unit 14 includes a risk information transmission unit 141, an inquiry transmission unit 142, and an outsourcing information transmission unit 143. The output unit 15 includes a tampering information output unit 151.

Each first terminal 2 includes a first storage unit 21, a first acceptance unit 22, a first processing unit 23, a first transmission unit 24, a first reception unit 25, and a first output unit 26.

Each second terminal 3 includes a second storage unit 31, a second acceptance unit 32, a second processing unit 33, a second transmission unit 34, a second reception unit 35, and a second output unit 36.

Each third terminal 4 includes a third storage unit 41, a third acceptance unit 42, a third processing unit 43, a third transmission unit 44, a third reception unit 45, and a third output unit 46.

The storage unit 11 included in the outsourcing management apparatus 1 stores various kinds of information. Examples of the various kinds of information include outsourcing information, which will be described later, outsourcee information, which will be described later, various kinds of clue information (including clue phrases), which will be described later, various learners, a learning module for machine learning, and a prediction module.

The outsourcing information storage unit 111 stores one or more pieces of outsourcing information. Outsourcing information is information regarding one instance of outsourcing of manufacturing. The subject of the outsourcing of manufacturing is typically a tangible object such as goods or products, but the subject may be an intangible object such as a design or a copyrighted work.

Outsourcing information includes, for example, two or more pieces of partial outsourcing information corresponding to one instance of outsourcing of manufacturing. Partial outsourcing information is a part of information that constitutes outsourcing information. Partial outsourcing information includes, for example, design right information, drawing information, designer information, agreement information, and quotation information.

Design right information is information regarding the design right owned by the outsourcer. Design right information includes, for example, a design publication file, the registration number of the design, and the identifiers (the company name, identification number, etc.) of the design right holder.

Drawing information is information regarding drawings of the subject of the outsourcing of manufacturing. Drawings include, for example, a parts drawing, an assembly drawing, a perspective view, and a six-sided view. Drawing information includes, for example, a file and image data, but there is no limitation on the data structure, data type, or the like thereof

Designer information is information regarding the designer who designed the subject of the outsourcing of manufacturing. Designer information includes, for example, a designer identifier that identifies the designer who designed the object of manufacturing consignment, date information that indicates the date the design was completed, and copyright identification information that the designer owns the copyright. The designer identifier is, for example, a name or an ID.

Agreement information is information regarding an outsourcing agreement, which is an agreement regarding the outsourcing of manufacturing. Agreement information includes, for example, a file and a set of strings, but there is no limitation on the data structure or the like thereof. Agreement information may include first liability avoidance information. First liability avoidance information is information indicating that the outsourcer is liable if the subject of the outsourcing of manufacturing infringes a third party's right. Agreement information may include subcontract prohibition information. Subcontract prohibition information is information indicating that a subcontract is prohibited.

Quotation information is information regarding a quotation for the outsourcing of manufacturing. Quotation information includes, for example, a file and a set of strings, but there is no limitation on the data structure or the like thereof

Outsourcing information includes, for example, an outsourcer identifier that identifies the outsourcer. Outsourcing information includes, for example, an outsourcee identifier that identifies the outsourcee. Outsourcing information includes, for example, a subcontractor identifier that identifies the subcontractor. Outsourcing information may be associated with one or more of the outsourcer identifier, the outsourcee identifier, and the subcontractor identifier, for example. The outsourcer identifier, the outsourcee identifier, and the subcontractor identifier are, for example, IDs or company names, but may be any information that can identify the outsourcer and so on. Outsourcing information typically includes an outsourcing identifier that identifies the outsourcing information.

Outsourcing information may be associated with subcontract agreement information. Subcontract agreement information is information regarding an agreement for a subcontract. Subcontract agreement information is information regarding an agreement that is to be executed in the case of subcontracting from the outsourcee to a subcontractor. Subcontract agreement information includes, for example, a file and a set of strings, but there is no limitation on the data structure or the like thereof. Subcontract agreement information may include second liability avoidance information. Second liability avoidance information is information indicating that the outsourcee is liable if infringement of a third party's right occurs.

The outsourcee information storage unit 112 stores one or more pieces of outsourcee information. The outsourcee information storage unit 112 may store one or more pieces of subcontractor information.

Outsourcee information is information regarding the outsourcee. Outsourcee information may be information regarding a potential outsourcee candidate. That is to say, the concept of an outsourcee may include a potential outsourcee candidate. Outsourcee information includes an outsourcee identifier that identifies the outsourcee. It is preferable that outsourcee information includes a trust score indicating the degree of trustworthiness of the outsourcee. Outsourcee information may include, for example, company information regarding a company that is the outsourcee. Company information includes, for example, a company name, a location, company financial information (annual sales, a listing status, etc.), and company information (representative directors, directors, the year of establishment, etc.).

Subcontractor information is information regarding the subcontractor. Subcontractor information may be information regarding a potential subcontractor candidate. That is to say, the concept of a subcontractor may include a potential subcontractor candidate. Subcontractor information includes a subcontractor identifier that identifies the subcontractor. It is preferable that subcontractor information includes a trust score indicating the degree of trustworthiness of the subcontractor. Subcontractor information may include, for example, company information regarding a company that is the subcontract.

The reception unit 12 receives various kinds of information and instructions. The reception unit 12 typically receives various kinds of information and instructions from a first terminal 2, a second terminal 3, and a third terminal 4. Examples of the various kinds of information and instructions include outsourcing information, permission information, which will be described later, an outsourcing information transmission instruction, which will be described later, a risk information transmission instruction, information regarding a subcontract, and an undertaking instruction.

Information regarding a subcontract includes, for example, subcontract agreement information, and an outsourcing identifier that identifies the outsourcing information on which the subcontract is based. Information regarding a subcontract includes, for example, a subject identifier that identifies the parts to be re-outsourced.

The undertaking instruction is information indicating the intention to undertake the outsourced manufacturing, or information indicating the intention to undertake the subcontract. The undertaking instruction includes, for example, an outsourcing identifier and an outsourcee identifier. The undertaking instruction includes, for example, an outsourcing identifier and a subcontractor identifier. The undertaking instruction includes, for example, a subject identifier.

The outsourcing information reception unit 121 receives outsourcing information from a first terminal 2. For example, the outsourcing information reception unit 121 receives outsourcing information in association with the outsourcer identifier that identifies the outsourcer that outsources manufacturing. Note that being associated with the outsourcer identifier may be including the outsourcer identifier.

The instruction reception unit 122 receives an outsourcing information transmission instruction. The outsourcing information transmission instruction is an instruction to transmit outsourcing information. The outsourcing information transmission instruction includes, for example, an outsourcing identifier. The outsourcing identifier is information that identifies outsourcing information, which is information that identifies the outsourcing of manufacturing. The outsourcing identifier is, for example, an ID, but there is no limitation. The instruction reception unit 122 typically receives an outsourcing information transmission instruction in association with an outsourcee identifier that identifies the outsourcee that is the user, or a subcontractor identifier that identifies the subcontractor that is the user. The instruction reception unit 122 receives an outsourcing information transmission instruction from a second terminal 3 or a third terminal 4.

The instruction reception unit 122 receives a risk information transmission instruction. The risk information transmission instruction is an instruction to transmit risk information. The risk information transmission instruction includes, for example, an outsourcing identifier. The instruction reception unit 122 typically receives a risk information transmission instruction in association with an outsourcee identifier that identifies the outsourcee that is the user, or a subcontractor identifier that identifies the subcontractor that is the user. The instruction reception unit 122 receives a risk information transmission instruction from a second terminal 3 or a third terminal 4.

The permission information reception unit 123 receives permission information from a first terminal 2. Permission information is information indicating that one or more pieces of partial outsourcing information determined by the determination unit 134, which will be described later, is permitted to be transmitted to a second terminal 3 or a third terminal 4. Permission information is, for example, information indicating whether or not to provide permission. Permission information includes, for example, the identifier of each of one or more pieces of partial outsourcing information that are permitted to be transmitted. Permission information includes, for example, the identifier of each of one or more pieces of partial outsourcing information that are not permitted to be transmitted.

Note that the permission information reception unit 123 receives, for example, permission information from a first terminal 2 in response to inquiry information being transmitted from the transmission unit 14 to the first terminal 2. Inquiry information is information used to inquire whether or not to permit transmission of the one or more pieces of partial outsourcing information determined by the determination unit 134 to a second terminal 3 or a third terminal 4. It is preferable that inquiry information includes information specifying each of the one or more pieces of partial outsourcing information determined by the determination unit 134, or each of the one or more pieces of partial outsourcing information determined by the determination unit 134. That is to say, it is preferable that the outsourcer can instruct whether or not to disclose each piece of partial outsourcing information.

The processing unit 13 performs various kinds of processing.

Examples of the various kinds of processing include processing performed by the tampering inspection unit 131, the outsourcing information accumulation unit 132, the risk information acquisition unit 133, the determination unit 134, and the subcontract prohibition processing unit 135.

The tampering inspection unit 131 inspects for tampering with the outsourcing information received by the outsourcing information reception unit 121. Various technologies, such as blockchain technology, timestamping technology, and digital watermarking technology, can be used to inspect tampering with information of a file or the like.

For example, the tampering inspection unit 131 uses blockchain technology to inspect for tampering with outsourcing information. In such a case, it is assumed that all or part of the outsourcing information is stored in two or more servers that constitute a blockchain. For example, the tampering inspection unit 131 executes a smart contract on the agreement information included in the outsourcing information received by the outsourcing information reception unit 121, to judge whether or not the agreement information is tampered information. Note that that the smart contracts, which is a blockchain technology, is well-known, and therefore a detailed description thereof will be omitted.

For example, the tampering inspection unit 131 uses a timestamp to inspect for tampering with outsourcing information. The tampering inspection unit 131 acquires, for example, the date and time information indicated by the timestamp embedded in the outsourcing information as a digital watermark. Also, the tampering inspection unit 131 acquires, for example, information regarding the update date and time of the file that is outsourcing information. The tampering inspection unit 131 judges that the outsourcing information has not been tampered with if the two pieces of date and time information match, and judges that the outsourcing information has been tampered with if the two pieces of date and time information do not match.

For example, the tampering inspection unit 131 uses digital watermark technology to inspect for tampering with outsourcing information. For example, the tampering inspection unit 131 substitutes the outsourcing information into a hash function to acquire a hash value. Thereafter, for example, the tampering inspection unit 131 acquires the digital watermark information embedded in the outsourcing information, and judges whether or not the digital watermark information and the hash value have a predetermined relationship (for example, matching). The tampering inspection unit 131 judges that the outsourcing information has not been tampered with if the digital watermark information and the hash value match, and judges that the outsourcing information has been tampered with if the digital watermark information and the hash value do not match.

Various algorithms may be used by the tampering inspection unit 131 to inspect outsourcing information for tampering, and one or more algorithms may be selected. Any algorithm may be selected.

The outsourcing information accumulation unit 132 accumulates the outsourcing information received by the outsourcing information reception unit 121. It is preferable that the outsourcing information accumulation unit 132 accumulates the outsourcing information received by the outsourcing information reception unit 121 if the tampering inspection unit 131 judges that the outsourcing information has not been tampered with. Note that “accumulation” typically is accumulation in the outsourcing information storage unit 111, but may be accumulation in another apparatus (not shown) (transmission to another apparatus).

The risk information acquisition unit 133 inspects outsourcing information to acquire risk information. Risk information is information regarding the risk in the case of undertaking the outsourced manufacturing corresponding to outsourcing information. The risk information is, for example, one or more kinds of information of risk presence/absence information indicating whether or not there is a risk, risk level information indicating a risk level, and risk detail information indicating the details of the risk. Risk level information indicates, for example, “one of five levels from 1 to 5”, “one of A, B, and C”, or the like. Risk detail information indicates, for example, “There is a possibility of infringement of a third party's design right”, “Possibility of infringement of a third party's design right is low”, “The outsourcer bears a risk. You can rest assured”, and “The subcontractor does not bear a risk. You can rest assured.”

The risk information acquisition unit 133 inspects outsourcing information, and, for example, if it is judged that the design right information included in the outsourcing information is information indicating that the outsourcer has the design right for the subject of the outsourcing of manufacturing, the risk information acquisition unit 133 acquires risk information indicating a risk level that is low enough to satisfy a predetermined condition.

The risk information acquisition unit 133 inspects outsourcing information, and, for example, if it is judged that the outsourcing information includes designer information, the risk information acquisition unit 133 acquires risk information indicating a risk level that is low enough to satisfy a predetermined condition.

If the agreement information included in the outsourcing information includes first liability avoidance information, the risk information acquisition unit 133 acquires risk information indicating a risk level that is low enough to satisfy a predetermined condition. First liability avoidance information is information indicating that the outsourcer is liable if the subject of the outsourcing of manufacturing infringes a third party's right. Examples of third party's right include intellectual property rights. Examples of intellectual property rights include design rights, patent rights, copyrights, and trademark rights.

There is no limitation on when the risk information acquisition unit 133 acquires risk information. For example, if the risk information acquisition unit 133 receives outsourcing information from a first terminal 2, the risk information acquisition unit 133 acquires risk information corresponding to the outsourcing information. For example, if the risk information acquisition unit 133 receives an outsourcing information transmission instruction from a second terminal 3, the risk information acquisition unit 133 acquires risk information. For example, if the risk information acquisition unit 133 receives a risk information transmission instruction from a second terminal 3, the risk information acquisition unit 133 acquires risk information. For example, if the risk information acquisition unit 133 receives an outsourcing information transmission instruction from a third terminal 4, the risk information acquisition unit 133 acquires risk information. For example, if the risk information acquisition unit 133 receives a risk information transmission instruction from a third terminal 4, the risk information acquisition unit 133 acquires risk information.

For example, a technology such as natural language processing or machine learning is used by the risk information acquisition unit 133 to inspect outsourcing information. The details of an example of the processing performed by the risk information acquisition unit 133 will be described with respect to the processing performed by the design right judgment part 1331, the designer judgment part 1332, the first liability judgment part 1333, the second liability judgment part 1334, and the risk information acquisition part 1335 included in the risk information acquisition unit 133.

The design right judgment part 1331 inspects the agreement information included in outsourcing information to judge whether or not the agreement information includes design right information. The design right judgment part 1331 inspects the agreement information included in outsourcing information to judge whether or not the agreement information includes the design right information corresponding to the subject of the outsourcing of manufacturing. Note that design right information is information regarding the design right owned by the outsourcer.

For example, the design right judgment part 1331 performs an inspection regarding either one or both of the following (1) and (2).

(1) Inspection for the presence/absence of information regarding a design right (1-1) In the case where the subject of the outsourcing of manufacturing is not taken into consideration

For example, the design right judgment part 1331 reads out a template for design registration numbers (for example, “Design Registration No. [0-9]+” or “No. [0-9]+”, where “[0-91+” is a regular expression) from the storage unit 11. Next, the design right judgment part 1331 inspects to judge whether or not a string that matches the template for registration numbers is included in the outsourcing information that is to be inspected. If a string that matches the template for registration numbers is included in the outsourcing information, the design right judgment part 1331 judges that design right information that leads to the conclusion that the outsourcer owns the design right for the subject of the outsourcing of manufacturing is included in the outsourcing information. Also, in such a case, the design right judgment part 1331 judges that the possibility of infringing a third party's design right is low.

(1-2) In the case where the subject of the outsourcing of manufacturing is taken into consideration

For example, the design right judgment part 1331 reads out a template for design registration numbers from the storage unit 11. Next, the design right judgment part 1331 acquires a subject identifier that identifies the subject of the outsourcing of manufacturing. Examples of the subject identifier include a product name, a part name, a product ID, and a part ID. Next, the design right judgment part 1331 judges that the design right information paired with the subject identifier is included in the outsourcing information. If the design right information paired with the subject identifier is included in the outsourcing information, the design right judgment part 1331 performs an inspection to judge whether or not the design right information includes a string that matches the template for design registration numbers. If a string that matches the template for registration numbers is included in the outsourcing information, the design right judgment part 1331 judges that design right information that leads to the conclusion that the outsourcer owns the design right for the subject of the outsourcing of manufacturing is included in the outsourcing information. Also, in such a case, the design right judgment part 1331 judges that the possibility of infringing a third party's design right is low.

Note that the design right judgment part 1331 acquires the subject identifier in the following manner, for example. The design right judgment part 1331 may acquire the subject identifier that is paired with the received outsourcee identifier, from the outsourcee information storage unit 112. The design right judgment part 1331 may acquire a subject identifier included in the agreement information in the outsourcing information that is to be inspected, through natural language processing, using clue phrases. Such processing through which a subject identifier is acquired is the same as the processing performed by the subject identifier acquisition part 1341, which will be described later. Note that there is no limitation on how to acquire a subject identifier.

(1-3) In the case where a machine learning algorithm is used

It is assumed that the storage unit 11 stores a design right presence/absence learner, which is a learner used to judge whether or not a design right is present. The design right judgment part 1331 provides the outsourcing information that is to be inspected and the design right presence/absence learner, to a prediction module for machine learning, which performs prediction processing regarding presence/absence of a design right, and acquires a prediction result indicating whether a design right is present or not, by executing the prediction module. If the prediction result indicates “design right present”, the design right judgment part 1331 judges that design right information that leads to the conclusion that the outsourcer owns the design right for the subject of the outsourcing of manufacturing is included in the outsourcing information. Also, in such a case, the design right judgment part 1331 judges that the possibility of infringing a third party's design right is low.

Note that the design right presence/absence learner is built by the processing unit 13 or the design right judgment part 1331 in the following manner: the processing unit 13 or the design right judgment part 1331 provides the learning module for machine learning with two or more pieces of training data, each being a set of outsourcing information and design right presence/absence information (indicating either “a design right is present” or “a design right is absent”), and forms a design right presence/absence learner by executing the learning module.

Any machine learning algorithm, such as deep learning, a decision tree, a random forest, an SVM, or the like, may be used. The learning module and the prediction module for machine learning are, for example, fastText, a TensorFlow module, a R language random forest module, TinySVM, or the like.

(2) Inspection for the presence/absence of a design publication
(2-1) In the case where the subject of the outsourcing of manufacturing is not taken into consideration

The design right judgment part 1331 judges whether or not a registered design publication file is included in the outsourcing information that is to be inspected. The design right judgment part 1331 judges, for example, whether or not a registered design publication file with a predetermined file name is included in the outsourcing information that is to be inspected. The predetermined file name is, for example, “Design Registration No. [0-9]+.pdf′ or “No. [0-9]+.pdf′. For example, the design right judgment part 1331 judges whether or not the outsourcing information that is to be inspected includes the clue information (for example, “Design Registration No. [0-9]+”) included in the registered design publication.

If a registered design publication file is included in the outsourcing information, the design right judgment part 1331 judges that design right information that leads to the conclusion that the outsourcer owns the design right for the subject of the outsourcing of manufacturing is included in the outsourcing information. Also, in such a case, the design right judgment part 1331 judges that the possibility of infringing a third party's design right is low.

(2-2) In the case where the subject of the outsourcing of manufacturing is taken into consideration

The design right judgment part 1331 judges whether or not a registered design publication file for the subject of the outsourcing of manufacturing is included in the outsourcing information that is to be inspected. The design right judgment part 1331 acquires the subject identifier that identifies the subject of the outsourcing of manufacturing. Next, the design right judgment part 1331 judges whether or not a registered design publication file that is paired with the acquired subject identifier is included in the outsourcing information that is to be inspected. That is to say, the design right judgment part 1331 judges, for example, whether or not a registered design publication file with a predetermined file name is included in the outsourcing information that is to be inspected. For example, the design right judgment part 1331 judges whether or not the outsourcing information that is to be inspected includes the clue information (for example, “Design Registration No. [0-9]+”) included in the registered design publication.

If a registered design publication file is included in the outsourcing information, the design right judgment part 1331 judges that design right information that leads to the conclusion that the outsourcer owns the design right for the subject of the outsourcing of manufacturing is included in the outsourcing information. Also, in such a case, the design right judgment part 1331 judges that the possibility of infringing a third party's design right is low.

The designer judgment part 1332 judges whether or not designer information is included in the outsourcing information that is to be inspected. For example, the designer judgment part 1332 judges whether or not information that is paired with information indicating designer information (for example, a designer information tag) is included in the outsourcing information. If designer information is included therein, the design right judgment part 1331 judges that the possibility of infringing a third party's design right is low.

The first liability judgment part 1333 inspects the agreement information included in the outsourcing information to judge whether or not the agreement information includes first liability avoidance information.

For example, the first liability judgment part 1333 performs an inspection regarding either one or both of the following (1) and (2).

(1) In the case of natural language processing performed using clue information

For example, the first liability judgment part 1333 performs a morphological analysis on the agreement information included in the outsourcing information that is to be inspected. For example, the first liability judgment part 1333 acquires the company name (for example, “Corporation A”) that is the noun phrase before the characters “First Party” that appear first in the agreement information. Also, the first liability judgment part 1333 acquires the company name (for example, “Corporation B”) that is the noun phrase before the characters “Second Party” that appear first in the agreement information. Next, the first liability judgment part 1333 acquires information indicating that the First Party is the outsourcer and the Second Party is the outsourcee from the phrases “the products of the First Party” and “outsourcing . . . to the Second Party” included in the sentence in which the “First Party” and the “Second Party” appear (for example, “Corporation A (hereinafter referred to as the “First Party”) and Corporation B (hereinafter referred to as the “Second Party”) enter into the following agreement (hereinafter referred to as the “Agreement”) for the continuous outsourcing of manufacturing of the products of the First Party to the Second Party”). Note that if clue phrases “the products of the First Party” and “outsourcing . . . to the Second Party” are included in the agreement information, the first liability judgment part 1333 judges that the First Party is the outsourcer and the Second Party is the outsourcee. On the other hand, if clue phrases (clue information) “the products of the Second Party” and “outsourcing . . . to the First Party” are included in the agreement information, the first liability judgment part 1333 judges that the Second Party is the outsourcer and the First Party is the outsourcee.

Next, the first liability judgment part 1333 judges whether or not the agreement information includes information in which the subject indicated by a reference term directed to the outsourcer (“First Party” or “Second Party”) is liable for infringement of a third party's right. For example, the first liability judgment part 1333 judges whether or not the agreement information includes a sentence that matches any of one or more patterns (clue information) such as “‘the reference term directed to the outsourcer’.*bear.*liability*for.*infringement.*rights”. Such patterns are referred to as “right infringement liability patterns”. If one or more sentences that match such right infringement liability patterns are included in the agreement information, the first liability judgment part 1333 judges that the agreement information includes first liability avoidance information. If no sentence that matches such right infringement liability patterns is included therein, the first liability judgment part 1333 judges that the agreement information does not include first liability avoidance information. Note that the storage unit 11 stores one or more right infringement liability patterns.

(2) In the case of machine learning

For example, the first liability judgment part 1333 acquires the reference term directed to the outsourcer through the processing described in (1). Next, the first liability judgment part 1333 provides each of the sentences included in the agreement information, the reference term directed to the outsourcer, and a first leaner, which is a leaner used to judge first liability avoidance information, to the prediction module for machine learning, and judges whether or not each sentence includes the first liability avoidance information corresponding to the reference term directed to the outsourcer, by executing the prediction module on each sentence. If at least one sentence that includes first liability avoidance information is present, the first liability judgment part 1333 judges that first liability avoidance information is present. If such a sentence is not present at all, the first liability judgment part 1333 judges that the agreement information does not include first liability avoidance information.

Note that the first learner is built by the processing unit 13 or the first liability judgment part 1333 in the following manner: the processing unit 13 or the first liability judgment part 1333 provides the learning module for machine learning with one or more positive examples each constituted by a sentence that includes first liability avoidance information and a reference term directed to the outsourcer, and one or more negative examples each constituted by a sentence that does not include first liability avoidance information, as training data, and forms a first learner by executing the learning module. It is preferable that the training data includes one or more negative examples each constituted by a sentence that includes first liability avoidance information and a reference term directed to the outsourcee (information indicating that the outsourcee is liable). The first learner is a learner for accepting a sentence and a reference term directed to the outsourcer, and predicting the result of the judgment regarding whether or not the sentence includes first liability avoidance information.

Note that the machine learning algorithm, learning module for machine learning, and prediction module described above can be used.

The second liability judgment part 1334 inspects the subcontract agreement information corresponding to the outsourcing information to judge whether or not the subcontract agreement information includes second liability avoidance information.

For example, the second liability judgment part 1334 performs an inspection regarding either one or both of the following (1) and (2).

(1) In the case of natural language processing performed using clue information

For example, the second liability judgment part 1334 performs a morphological analysis on the subcontract agreement information that is to be inspected. For example, the second liability judgment part 1334 acquires the company name that is the noun phrase before the characters “First Party” that appear first in the subcontract agreement information. Also, the second liability judgment part 1334 acquires the company name that is the noun phrase before the characters “Second Party” that appear first in the subcontract agreement information.

Next, the second liability judgment part 1334 judges whether or not a sentence that matches a sentence pattern such as “First Party.*re-outsource to.*Second Party” is included in the sentences in which the “First Party” and the “Second Party” appear. If such a sentence is included therein, the second liability judgment part 1334 determines that the “First Party” is the outsourcee and the “Second Party” is the subcontractor. On the other hand, if a sentence that matches a sentence pattern such as “.*re-outsourced from.*Second Party to First Party” is present, the second liability judgment part 1334 determines that the Second Party is the outsourcee and the First Party is the subcontractor.

Next, the second liability judgment part 1334 judges whether or not a sentence in which the subject is indicated by a reference term directed to the outsourcee (“First Party” or “Second Party”), and that matches any of the right infringement liability patterns is included in the subcontract agreement information. If one or more sentences that match such right infringement liability patterns are included, the second liability judgment part 1334 judges that the subcontract agreement information includes second liability avoidance information. If no sentence that matches such right infringement liability patterns is included therein, the second liability judgment part 1334 judges that the subcontract agreement information does not include second liability avoidance information. Note that the storage unit 11 stores one or more rights infringement liability patterns.

(2) In the case of machine learning

For example, the second liability judgment part 1334 acquires the reference term directed to the outsourcee through the processing described in

(1). Next, the second liability judgment part 1334 provides each of the sentences included in the subcontract agreement information, the reference term directed to the outsourcee, and a second leaner, which is a leaner used to judge second liability avoidance information, to the prediction module for machine learning, and judges whether or not each sentence includes the second liability avoidance information corresponding to the reference term directed to the outsourcer, by executing the prediction module on each sentence. If at least one sentence that includes second liability avoidance information is included in the subcontract agreement information, the second liability judgment part 1334 judges that the subcontract agreement information includes second liability avoidance information. If such a sentence is not present at all, the second liability judgment part 1334 judges that the subcontract agreement information does not include second liability avoidance information.

Note that the second learner is built by the processing unit 13 or the second liability judgment part 1334 in the following manner: the processing unit 13 or the second liability judgment part 1334 provides the learning module for machine learning with one or more positive examples each constituted by a sentence that includes second liability avoidance information and a reference term directed to the outsourcee, and one or more negative examples each constituted by a sentence that does not include second liability avoidance information, as training data, and forms a second learner by executing the learning module. It is preferable that the training data includes one or more negative examples each constituted by a sentence that includes second liability avoidance information and a reference term directed to the subcontractor (information indicating that the subcontractor is liable). The second learner is a learner for accepting a sentence and a reference term directed to the outsourcee, and predicting the result of the judgment regarding whether or not the sentence includes second liability avoidance information.

Note that the machine learning algorithm, learning module for machine learning, and prediction module described above can be used.

The risk information acquisition part 1335 acquires risk information. It is preferable that the risk information acquisition part 1335 uses the results of the judgement by one or more parts of the design right judgment part 1331, the designer judgment part 1332, the first liability judgment part 1333, and the second liability judgment part 1334 to acquire risk information.

For example, if the design right judgment part 1331 judges that the outsourcer has the design right for the subject of the outsourcing of manufacturing, the risk information acquisition part 1335 acquires risk information indicating a risk level that is low enough to satisfy a predetermined condition. When the design right judgment part 1331 judges that the outsourcer has the design right for the subject of the outsourcing of manufacturing, the risk information acquisition part 1335 acquires risk information specifying a risk level that is lower (for example, risk level information indicating a lower risk) than when the design right judgment part 1331 judges that the outsourcer does not have the design right for the subject of the outsourcing of manufacturing.

For example, if the designer judgment part 1332 judges that the outsourcing information to be inspected includes designer information, the risk information acquisition part 1335 acquires risk information indicating a risk level that is low enough to satisfy a predetermined condition. For example, when the designer judgment part 1332 judges that the outsourcing information to be inspected includes designer information, the risk information acquisition part 1335 acquires risk information specifying a risk level that is lower (for example, risk level information indicating a lower risk) than when the designer judgment part 1332 judges that the outsourcing information to be inspected does not include designer information.

For example, if the first liability judgment part 1333 judges that first liability avoidance information is present, the risk information acquisition part 1335 acquires risk information indicating a risk level that is low enough to satisfy a predetermined condition. For example, when the first liability judgment part 1333 judges that first liability avoidance information is present, the risk information acquisition part 1335 acquires risk information specifying a risk level that is lower (for example, risk level information indicating a lower risk) than when the first liability judgment part 1333 judges that first liability avoidance information is not present.

For example, if the second liability judgment part 1334 judges that second liability avoidance information is present, the risk information acquisition part 1335 acquires risk information that is for the subcontractor and indicates a risk level that is low enough to satisfy a predetermined condition. For example, when the second liability judgment part 1334 judges that second liability avoidance information is present, the risk information acquisition part 1335 acquires risk information specifying a risk level that is lower (for example, risk level information indicating a lower risk) than when the second liability judgment part 1334 judges that second liability avoidance information is not present.

For example, the risk information acquisition part 1335 uses the results of the judgement by one or more parts of the design right judgment part 1331, the designer judgment part 1332, the first liability judgment part 1333, and the second liability judgment part 1334 to acquire risk presence/absence information.

For example, if the design right judgment result acquired by the design right judgment part 1331 indicates “design right present”, the risk information acquisition part 1335 acquires risk presence/absence information indicating “no risk”. For example, if the designer judgment result acquired by the designer judgment part 1332 indicates “designer present”, the risk information acquisition part 1335 acquires risk presence/absence information indicating “no risk”. For example, if the first liability judgment result acquired by the first liability judgment part 1333 indicates “not liable”, the risk information acquisition part 1335 acquires risk presence/absence information indicating “no risk”. For example, if the second liability judgment result acquired by the second liability judgment part 1334 indicates “not liable”, the risk information acquisition part 1335 acquires risk presence/absence information indicating “no risk”. For example, if the design right judgment result indicates “design right absent”, the designer judgment result indicates “designer absent”, and the first liability judgment result indicates “liable”, the risk information acquisition part 1335 acquires risk presence/absence information indicating “at risk”. For example, if the design right judgment result indicates “design right absent”, the designer judgment result indicates “designer absent”, and the second liability judgment result indicates “liable”, the risk information acquisition part 1335 acquires risk presence/absence information indicating “at risk”.

For example, the risk information acquisition part 1335 uses the results of the judgement by one or more parts of the design right judgment part 1331, the designer judgment part 1332, the first liability judgment part 1333, and the second liability judgment part 1334 to acquire risk level information.

For example, the risk information acquisition part 1335 acquires risk level information that is paired with each of the design right judgment result; the designer judgment result; and the first liability judgement result, from a risk correspondence table that is stored in the storage unit 11. For example, the risk information acquisition part 1335 acquires risk level information that is paired with each of the design right judgment result; the designer judgment result; and the second liability judgement result, from the risk correspondence table that is stored in the storage unit 11. The risk correspondence table is a table that includes two or more pieces of correspondence information each including a set consisting of a design right judgment result, a designer judgment result, and a first liability judgement result or a second liability judgement result, and risk level information.

For example, the risk information acquisition part 1335 acquires risk level information by substituting, as parameters, the design right judgment result, the designer judgment result, and the first liability judgement result, into an arithmetic expression for calculating the risk level information and executing the arithmetic expression. For example, the risk information acquisition part 1335 acquires risk level information by substituting, as parameters, the design right judgment result, the designer judgment result, and the second liability judgement result, into the arithmetic expression for calculating the risk level information and executing the arithmetic expression. Such an arithmetic expression is stored in the storage unit 11.

For example, the risk information acquisition part 1335 acquires risk level information by providing the prediction module for machine learning with the design right judgment result, the designer judgment result, the first liability judgement result, and the risk learner, and executing the prediction module. For example, the risk information acquisition part 1335 acquires risk level information by providing the prediction module for machine learning with the design right judgment result, the designer judgment result, the second liability judgement result, and the risk learner, and executing the prediction module. Note that the risk learner is a learner formed by providing the learning module for machine learning with two or more pieces of training data each including a design right judgment result, a designer judgment result, a first liability judgement result or a second liability judgement result, and risk level information, and executing the learning module. In such cases, deep learning or SVR is a suitable machine learning algorithm.

For example, the risk information acquisition part 1335 uses the results of the judgement by one or more parts of the design right judgment part 1331, the designer judgment part 1332, the first liability judgment part 1333, and the second liability judgment part 1334 to acquire risk detail information.

For example, the risk information acquisition part 1335 acquires risk detail information that includes a design right judgment result, a designer judgment result, and a first liability judgement result. For example, the risk information acquisition part 1335 acquires risk detail information that includes a design right judgment result, a designer judgment result, and a second liability judgement result.

The determination unit 134 determines one or more pieces of partial outsourcing information that are to be disclosed to the outsourcee or the subcontractor. The determination unit 134 functions to disclose only the information necessary for outsourcing work and to protect the property (including intangible property) of the outsourcer of the outsourcing of manufacturing. Determining one or more pieces of partial outsourcing information is, for example, acquiring one or more pieces of partial outsourcing information is, acquiring the identifier(s) of one or more pieces of partial outsourcing information, or acquiring link(s) to one or more pieces of partial outsourcing information.

For example, the determination unit 134 acquires an outsourcee identifier or a subcontractor identifier corresponding to the outsourcing information transmission instruction received by the instruction reception unit 122. Next, the determination unit 134 acquires one or more pieces of partial outsourcing information that are to be disclosed to the user identified by the outsourcee identifier or the subcontractor identifier, using one or more pieces of specification information that are respectively associated with one or more pieces of partial outsourcing information. Specification information includes, for example, a subject identifier that identifies the subject of the outsourcing of manufacturing. Specification information includes, for example, an outsourcee identifier.

For example, the determination unit 134 uses a trust score that is paired with the outsourcee identifier or the subcontractor identifier, to determine one or more pieces of partial outsourcing information. The determination unit 134 discloses more partial outsourcing information to users with high trust scores (highly trusted users) compared to users with low scores.

For example, if the trust score is high enough to satisfy a predetermined condition (for example, no less than a threshold value or greater than a threshold value), the determination unit 134 determines to disclose all the pieces of partial outsourcing information included in the outsourcing information corresponding to the outsourcing identifier.

For example, if the trust score is high enough to satisfy a predetermined condition, the determination unit 134 determines to also disclose the piece of partial outsourcing information that is paired with the subject identifier of the finished product that is associated with the subject identifier that identifies the part that is the subject of the outsourcing of manufacturing.

The subject identifier acquisition part 1341 inspects agreement information to acquire a subject identifier. For example, the subject identifier acquisition part 1341 uses clue information to acquire a subject identifier. When clue information is “the following product”, the subject identifier acquisition part 1341 acquires, for example, a noun phrase after “note” and “line feed” after “the following product” as the subject identifier. Alternatively, for example, the subject identifier acquisition part 1341 uses one or more pieces of clue information to acquire a subject identifier through a natural language processing technology. Note that, in the case of inspecting agreement information, the subject identifier acquisition part 1341 may use any kind of clue information to acquire a subject identifier.

For example, the subject identifier acquisition part 1341 acquires the subject identifier received in association with agreement information.

The determination part 1342 determines one or more pieces of partial outsourcing information that include one or more pieces of partial outsourcing information that are paired with the subject identifier acquired by the subject identifier acquisition part 1341. For example, the determination part 1342 acquires subject identifier(s) that are respectively paired with pieces of partial outsourcing information included in the outsourcing information that is to be inspected in the outsourcing information storage unit 111. Thereafter, for example, the determination part 1342 determines one or more pieces of partial outsourcing information that are paired with the subject identifier that matches the subject identifier acquired by the subject identifier acquisition part 1341. In addition, the determination part 1342 determines partial outsourcing information that can be disclosed to all outsourcees or outsourcee candidates, as partial outsourcing information that is to be disclosed. Note that partial outsourcing information that can be disclosed to all outsourcees or outsourcee candidates is, for example, partial outsourcing information that is not associated with the subject identifier, or partial outsourcing information that is associated with a flag indicating that the partial outsourcing information can be disclosed to all.

The determination part 1342 typically does not determine partial outsourcing information that is paired only with a subject identifier other than the subject identifier acquired by the subject identifier acquisition part 1341, as partial outsourcing information that is to be disclosed.

The subcontract prohibition processing unit 135 judges whether or not subcontract prohibition information that prohibits a subcontract is included in the agreement information, and if the subcontract prohibition processing unit 135 judges that subcontract prohibition information is included therein, the subcontract prohibition processing unit 135 performs subcontract prohibition processing to prohibit subcontract.

For example, the subcontract prohibition judgment part 1351 judges whether or not a sentence that matches any of one or more subcontract prohibition patterns is included in the agreement information. The subcontract prohibition patterns are sentence patterns used to judge subcontract prohibition information. Examples of subcontract prohibition patterns include “subcontract.*prohibited” and “subcontract is prohibited”. One or more subcontract prohibition patterns are stored in the storage unit 11.

For example, the subcontract prohibition judgment part 1351 provides the prediction module for machine learning with each sentence in the agreement information and a subcontract prohibition information learner, to acquire information for each sentence, regarding whether or not the sentence includes subcontract prohibition information. Note that the subcontract prohibition information learner is a learner that is acquired through learning processing using, as training data, one or more sentences that each include subcontract prohibition information and one or more sentences that each does not include subcontract prohibition information. Such a learner is formed by the processing unit 13 or the subcontract prohibition judgment part 1351.

If the subcontract prohibition judgment part 1351 that subcontract is prohibited, the subcontract prohibition processing part 1352 performs subcontract prohibition processing. Subcontract prohibition processing is processing that is performed to prohibit subcontract. Subcontract prohibition processing is, for example, processing that is performed not to accumulate the received information regarding a subcontract. Subcontract prohibition processing is, for example, processing that is performed, if information regarding a subcontract is received, to return error information to the terminal that has been transmitted the information regarding a subcontract. Subcontract prohibition processing is, for example, processing that is performed to transmit error information indicating that information regarding a subcontract has been transmitted even though subcontract is prohibited, to a first terminal 2. In addition, subcontract prohibition processing may be any kind of processing related to prohibiting subcontract.

The transmission unit 14 transmits various kinds of information. Examples of the various kinds of information include risk information, outsourcing information, and partial outsourcing information. The transmission unit 14 transmits various kinds of information to a first terminal 2, a second terminal 3, or a third terminal 4.

The risk information transmission unit 141 transmits the risk information acquired by the risk information acquisition unit 133 to a second terminal 3. The risk information transmission unit 141 may transmit the risk information acquired by the risk information acquisition unit 133 to a first terminal 2. The risk information transmission unit 141 may transmit the risk information acquired by the risk information acquisition unit 133 to a third terminal 4.

Before the outsourcing information transmission unit 143 transmits outsourcing information or partial outsourcing information to a second terminal 3 or third terminal 4, the inquiry transmission unit 142 transmits inquiry information to the second terminal 3 or the third terminal 4 to check whether or not the transmission is permitted.

The outsourcing information transmission unit 143 transmits the one or more pieces of partial outsourcing information determined by the determination unit 134, to the second terminal or the third terminal.

It is preferable that the outsourcing information transmission unit 143 transmits only one or more pieces of partial outsourcing information corresponding to the permission information received by the permission information reception unit 123, to the second terminal.

The output unit 15 outputs various kinds of information. The various kinds of information are pieces of tampering information. Here, the output is typically transmission to an external apparatus. However, the output may be a concept that also encompasses display on a display screen, projection using a projector, printing by a printer, the output of a sound, accumulation on a recording medium, delivery of a processing result to another processing apparatus or another program, and the like.

The tampering information output unit 151 outputs tampering information regarding tampering if the result of the inspection by the tampering inspection unit 131 indicates that the outsourcing information has been tampered with. The tampering information output unit 151 outputs tampering information to a first terminal 2, a second terminal 3, or a third terminal 4, for example.

The first storage unit 21 included in each first terminal 2 stores various kinds of information. Examples of the various kinds of information include an outsourcer identifier and a terminal identifier. Note that the terminal identifier may be the same as the outsourcer identifier.

The first acceptance unit 22 accepts various kinds of instructions and information. Examples of the various kinds of instructions and information include outsourcing information, one or more pieces of partial outsourcing information, and permission information. It is preferable that outsourcing information or partial outsourcing information is associated with a subject identifier.

The means for inputting various kinds of instructions and information may be any means such as a touch panel, a keyboard, a mouse, a means that employs a menu screen, or the like.

The first processing unit 23 performs various kinds of processing. Examples of the various kinds of processing include processing that is performed to convert various kinds of instructions and information accepted by the first acceptance unit 22 into instructions and information that are to be transmitted. Examples of the various kinds of processing include processing that is performed to convert information received by the first reception unit 25 into information that is to be output.

The first transmission unit 24 transmits various kinds of instructions and information to the outsourcing management apparatus 1. Examples of the various kinds of instructions and information include outsourcing information, and one or more pieces of partial outsourcing information.

The first reception unit 25 receives various kinds of information from the outsourcing management apparatus 1. Examples of the various kinds of information include risk information.

The first output unit 26 outputs various kinds of information. Examples of the various kinds of information include risk information.

Here, the output is a concept that encompasses display on a display screen, projection using a projector, printing by a printer, the output of a sound, transmission to an external apparatus, accumulation on a recording medium, delivery of a processing result to another processing apparatus or another program, and the like.

The second storage unit 31 included in each second terminal 3 stores various kinds of information. Examples of the various kinds of information include an outsourcee identifier and a terminal identifier.

The second acceptance unit 32 accepts various kinds of instructions and information. Examples of the various kinds of instructions and information include an outsourcing information transmission instruction, a risk information transmission instruction, an undertaking instruction, and information regarding a subcontract. Note that the undertaking instruction is information indicating the intention to undertake the outsourced manufacturing. The undertaking instruction includes, for example, an outsourcing identifier and an outsourcee identifier. Information regarding a subcontract includes subcontract agreement information. Information regarding a subcontract includes, for example, an outsourcee identifier (the identifier of a subcontractor), a subcontractor identifier, and a subject identifier.

The means for inputting various kinds of instructions and information may be any means such as a touch panel, a keyboard, a mouse, a means that employs a menu screen, or the like.

The second processing unit 33 performs various kinds of processing. Examples of the various kinds of processing include processing that is performed to convert various kinds of instructions and information accepted by the second acceptance unit 32 into instructions and information that are to be transmitted. Examples of the various kinds of processing include processing that is performed to convert information received by the second reception unit into information that is to be output.

The second transmission unit 34 transmits various kinds of instructions and information to the outsourcing management apparatus 1. Examples of the various kinds of instructions and information include an outsourcing information transmission instruction, a risk information transmission instruction, and an undertaking instruction.

The second reception unit 35 receives various kinds of information from the outsourcing management apparatus 1. Examples of the various kinds of information include risk information, outsourcing information, partial outsourcing information, and error information, which will be described later.

The second output unit 36 outputs various kinds of information. Examples of the various kinds of information include risk information, outsourcing information, and partial outsourcing information.

Here, the output is a concept that encompasses display on a display screen, projection using a projector, printing by a printer, the output of a sound, transmission to an external apparatus, accumulation on a recording medium, delivery of a processing result to another processing apparatus or another program, and the like.

The third storage unit 41 included in each third terminal 4 stores various kinds of information. Examples of the various kinds of information include a subcontractor identifier and a terminal identifier.

The third acceptance unit 42 accepts various kinds of instructions and information. Examples of the various kinds of instructions and information include an outsourcing information transmission instruction, a risk information transmission instruction, a subcontract undertaking instruction, and information regarding a subcontract. Note that the subcontract undertaking instruction is information indicating that the subcontract is to be undertaken. The subcontract undertaking instruction includes, for example, an outsourcing identifier, a subcontractor identifier, and the subject identifier of the subject of the subcontract.

The means for inputting various kinds of instructions and information may be any means such as a touch panel, a keyboard, a mouse, a means that employs a menu screen, or the like.

The third processing unit 43 performs various kinds of processing. Examples of the various kinds of processing include processing that is performed to convert various kinds of instructions and information accepted by the third acceptance unit 42 into instructions and information that are to be transmitted. Examples of the various kinds of processing include processing that is performed to convert information received by the third reception unit 45 into information that is to be output.

The third transmission unit 44 transmits various kinds of instructions and information to the outsourcing management apparatus 1. Examples of the various kinds of instructions and information include an outsourcing information transmission instruction, a risk information transmission instruction, and a subcontract undertaking instruction.

The third reception unit 45 receives various kinds of information from the outsourcing management apparatus 1. Examples of the various kinds of information include risk information, outsourcing information, partial outsourcing information, and error information, which will be described later.

The third output unit 46 outputs various kinds of information.

Examples of the various kinds of information include risk information, outsourcing information, and partial outsourcing information.

Here, the output is a concept that encompasses display on a display screen, projection using a projector, printing by a printer, the output of a sound, transmission to an external apparatus, accumulation on a recording medium, delivery of a processing result to another processing apparatus or another program, and the like.

It is preferable that the storage unit 11, the outsourcing information storage unit 111, the outsourcee information storage unit 112, the first storage unit 21, the second storage unit 31, and the third storage unit 41 are realized using a non-volatile recording medium, but they may be realized using a volatile recording medium.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The reception unit 12, the outsourcing information reception unit 121, the instruction reception unit 122, the permission information reception unit 123, the first reception unit 25, the second reception unit 35, and the third reception unit 45 typically are realized using a wireless or wired communication means, but may be realized using a broadcast receiving means

The processing unit 13, the tampering inspection unit 131, the outsourcing information accumulation unit 132, the risk information acquisition unit 133, the determination unit 134, the subcontract prohibition processing unit 135, the first liability judgment part 1333, the second liability judgment part 1334, the risk information acquisition part 1335, the subject identifier acquisition part 1341, the determination part 1342, the subcontract prohibition judgment part 1351, the subcontract prohibition processing part 1352, the first processing unit 23, the second processing unit 33, and the third processing unit 43 can typically be realized using a processor, a memory, or the like. The processing procedures performed by the processing unit 13 or the like typically are realized using software, and the software is recorded on a recording medium such as a ROM. However, such processing procedures may be realized using hardware (a dedicated circuit). The processor is a CPU, an MPU, a GPU, or the like, and there is no limitation on the type thereof.

The transmission unit 14, the risk information transmission unit 141, the inquiry transmission unit 142, the outsourcing information transmission unit 143, the output unit 15, the tampering information output unit 151, the first transmission unit 24, the second transmission unit 34, and the third transmission unit 44 typically are realized using a wireless or wired communication means, but may be realized using a broadcast receiving means

The first acceptance unit 22, the second acceptance unit 32, and the third acceptance unit 42 can be realized using a device driver for the input means such as a touch panel or a keyboard, or control software or the like for controlling the menu screen.

The first output unit 26, the second output unit 36, and the third output unit 46 may be regarded as including or not including an output device such as a display or a speaker. The first output unit 26 or the like can be realized using the driver software of the output device, the driver software of the output device and the output device, or the like.

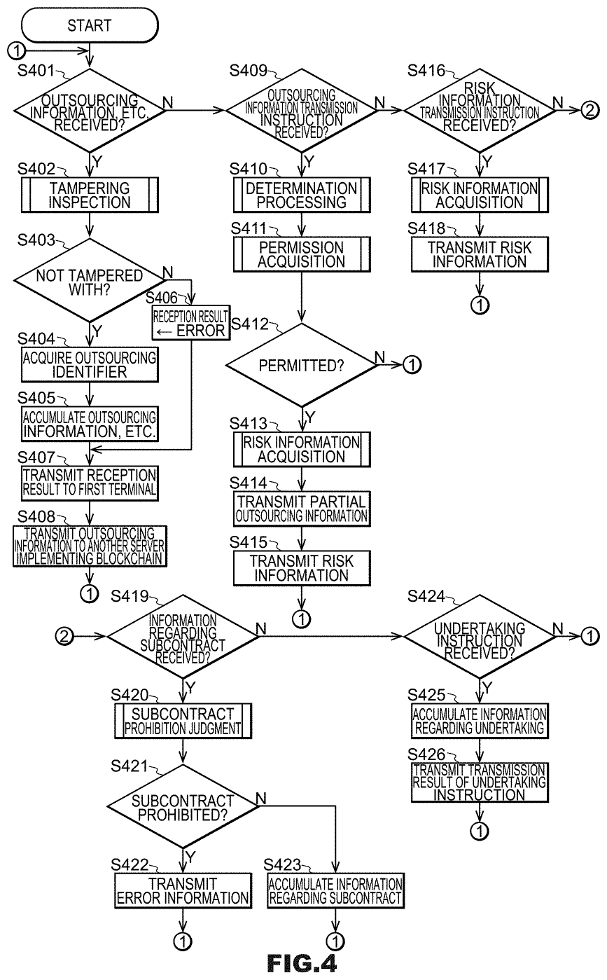

Next, examples of operations of the outsourcing management system A will be described. First, examples of operations of the outsourcing management apparatus 1 included in the outsourcing management system A will be described with reference to the flowchart in FIG. 4.

(Step S401) The outsourcing information reception unit 121 judges whether or not outsourcing information has been received from a first terminal 2. If outsourcing information has been received, processing proceeds to step S402, and if outsourcing information has not been received, processing proceeds to step S409.

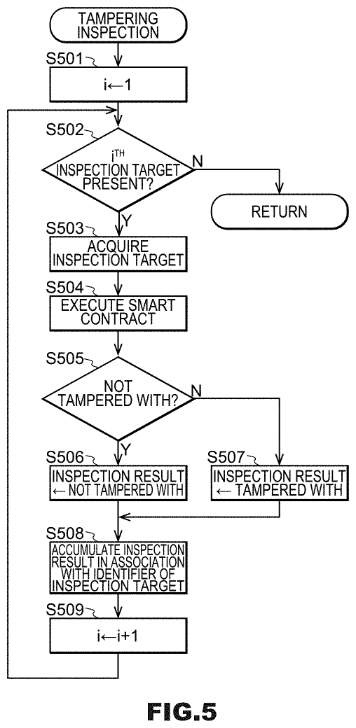

(Step S402) The tampering inspection unit 131 performs a tempering inspection on the outsourcing information received in step S401. An example of tampering inspection processing will be described with reference to the flowchart in FIG. 5.

(Step S403) As a result of the tampering inspection in step S402, if the information has not been tampered with, processing proceeds to step S404, and if the information has been tampered with, processing proceeds to step S406.

(Step S404) The tampering information output unit 151 acquires the outsourcing identifier corresponding to the outsourcing information received in step S401. Note that the tampering information output unit 151 may acquire the outsourcing identifier included in the outsourcing information received in step S401, or generate a unique outsourcing identifier that identifies the outsourcing of manufacturing corresponding to the outsourcing information received in step S401. Note that there is no limitation on the algorithm for generating the outsourcing identifier. For example, an ID may be generated by adding “1” to the latest outsourcing identifier. In addition, the tampering information output unit 151 forms a reception result that is information including the outsourcing identifier and indicating that the outsourcing information has been normally accepted. Note that the reception result is the result of receiving outsourcing information.

(Step S405) The tampering information output unit 151 accumulates the outsourcing information and so on in the outsourcing information storage unit 111. Processing proceeds to step S407. Note that the outsourcing information or the like includes the outsourcing information received in step S401 and the outsourcing identifier acquired in step S404. The outsourcing information or the like may include the outsourcer identifier received in pair with the outsourcing information in step S401.

(Step S406) The tampering information output unit 151 substitutes information indicating an error in the reception result.

(Step S407) The tampering information output unit 151 transmits the reception result to the first terminal 2 from which the outsourcing information has been transmitted.

(Step S408) The transmission unit 14 transmits the outsourcing information to another server implementing the blockchain. Processing returns to step S401. Note that, as a result of such transmission, the outsourcing information is managed in the blockchain.

(Step S409) The instruction reception unit 122 judges whether or not an outsourcing information transmission instruction has been received from a second terminal 3 or a third terminal 4. If an outsourcing information transmission instruction has been received, processing proceeds to step S410, and if an outsourcing information transmission instruction has not been received, processing proceeds to step S416.

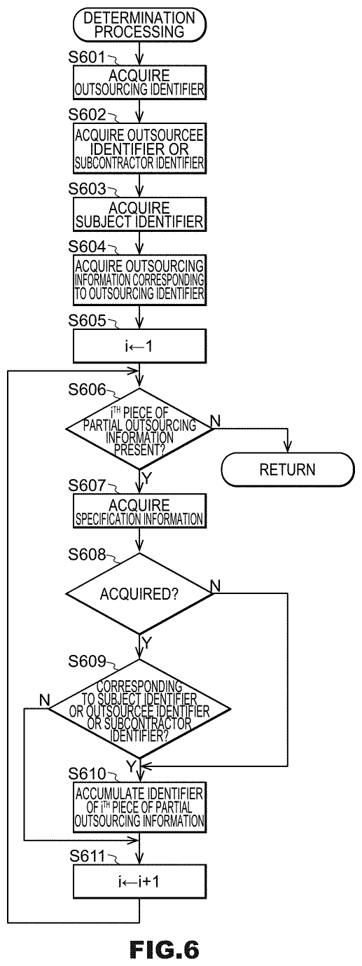

(Step S410) The determination unit 134 performs processing to determine the partial outsourcing information to be transmitted to a second terminal 3 or a third terminal 4. An example of such determination processing will be described with reference to the flowchart in FIG. 6.

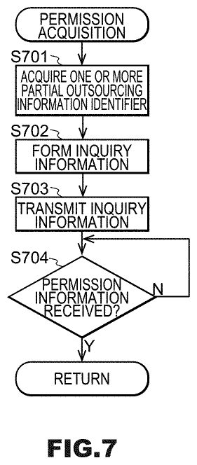

(Step S411) The processing unit 13 and so on perform processing to acquire permission to transmit the one or more pieces of partial outsourcing information determined in step S410, to a second terminal 3 or a third terminal 4. An example of such permission acquisition processing will be described with reference to the flowchart in FIG. 7.

(Step S412) The processing unit 13 judges whether or not one or more pieces of partial outsourcing information that have been permitted in step S411 are present. If such pieces of partial information are present, processing proceeds to step S413, and if not, processing returns to step S401.

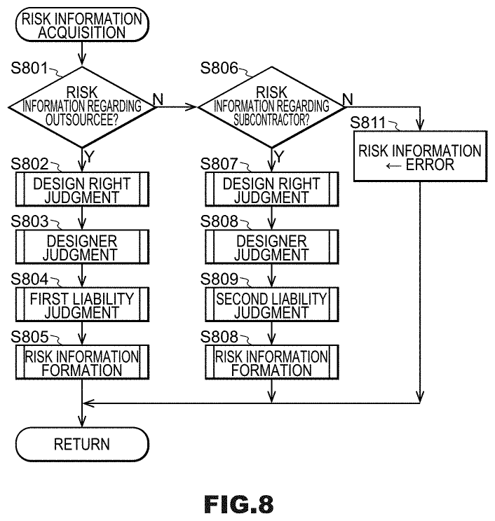

(Step S413) The risk information acquisition unit 133 acquires risk information. An example of such risk information acquisition processing will be described with reference to the flowchart in FIG. 8.

(Step S414) The outsourcing information transmission unit 143 transmits the one or more pieces of partial outsourcing information that have been permitted, to the second terminal 3 or the third terminals 4 from which the outsourcing information transmission instruction has been transmitted.

(Step S415) The risk information transmission unit 141 transmits the risk information acquired in step S413 to the second terminal 3 or the third terminal 4 from which the outsourcing information transmission instruction has been transmitted. Processing returns to step S401.

(Step S416) The instruction reception unit 122 judges whether or not a risk information transmission instruction has been received. If a risk information transmission instruction has been received, processing proceeds to step S417, and if a risk information transmission instruction has not been received, processing proceeds to step S419.

(Step S417) The risk information transmission unit 141 acquires outsourcing information corresponding to the risk information transmission instruction, or risk information for one or more pieces of partial outsourcing information corresponding to the risk information transmission instruction. An example of such risk information acquisition processing will be described with reference to the flowchart in FIG. 8.

(Step S418) The risk information transmission unit 141 transmits the risk information acquired in step S417 to the first terminal 2, the second terminal 3, or the third terminal 4 from which the risk information transmission instruction has been transmitted. Processing returns to step S401.

(Step S419) The reception unit 12 judges whether or not information regarding a subcontract has been received. If information regarding a subcontract has been received, processing proceeds to step S420, and if information regarding a subcontract has not been received, processing returns to step S401.

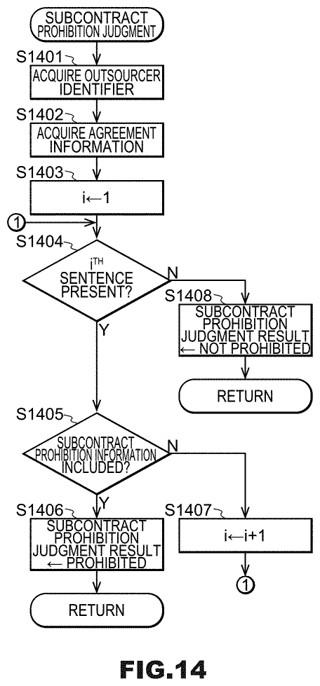

(Step S420) The subcontract prohibition judgment part 1351 performs subcontract prohibition judgment processing. An example of subcontract prohibition judgment processing will be described with reference to the flowchart in FIG. 14.

(Step S421) As a result of the subcontract prohibition judgment processing in step S420, if a subcontract is prohibited, processing proceeds to step S422, and if a subcontract is not prohibited, processing proceeds to step S423.

(Step S422) The subcontract prohibition processing part 1352 forms error information indicating that a subcontract is prohibited, and transmits the error information to the terminal from which information regarding a subcontract has been transmitted. Processing returns to step S401.

(Step S423) The subcontract prohibition processing part 1352 accumulates the received information regarding a subcontract in association with the outsourcing identifier. Processing returns to step S401.

(Step S424) The reception unit 12 judges whether or not an undertaking instruction has been received. If an undertaking instruction has been received, processing proceeds to step S425, and if an undertaking instruction has not been received, processing returns to step S401.

(Step S425) The processing unit 13 forms, for example, information regarding the undertaking of the outsourcing of manufacturing identified by the outsourcing identifier included in the undertaking instruction, according to the undertaking instruction received in step S424. Thereafter, the processing unit 13 accumulates such information regarding undertaking in the storage unit 11 in association with the outsourcing identifier. Note that information regarding undertaking includes, for example, an outsourcing identifier and an outsourcee identifier. Information regarding undertaking includes, for example, an outsourcing identifier, an outsourcee identifier, and a subject identifier.

The processing unit 13 forms, for example, information regarding the undertaking of a subcontract of the outsourcing of manufacturing identified by the outsourcing identifier included in the undertaking instruction, according to the undertaking instruction received in step S424. Thereafter, the processing unit 13 accumulates such information regarding undertaking in the storage unit 11 in association with the outsourcing identifier. Note that information regarding undertaking includes, for example, an outsourcing identifier and a subcontractor identifier. Information regarding undertaking includes, for example, an outsourcing identifier, a subcontractor identifier, and a subject identifier. Information regarding undertaking includes, for example, an outsourcing identifier, an outsourcee identifier, and a subcontractor identifier. Information regarding undertaking includes, for example, an outsourcing identifier, an outsourcee identifier, a subcontractor identifier, and a subject identifier.

(Step S426) The transmission unit 14 transmits the result of transmission of the undertaking instruction, indicating “normally processed”, to the terminal from which the undertaking instruction has been transmitted. Processing returns to step S401.

Note that, in the flowchart in FIG. 4, processing ends when the power is turned off or an interruption occurs to end the processing.

Next, an example of the tampering inspection processing in step S402 will be described with reference to the flowchart in FIG. 5.

(Step S501) The tampering inspection unit 131 substitutes 1 for a counter i.

(Step S502) The tampering inspection unit 131 judges whether or not the ith inspection target is present. If the ith inspection target is present, processing proceeds to step S503, and if the ith inspection target is not present, processing returns to higher-level processing. Note that the ith inspection target typically is the partial outsourcing information included in the outsourcing information received in step S401, and is, for example, design right information, drawing information, designer information, agreement information, quotation information, or subcontract agreement information. The ith inspection target may also be agreement information only.

(Step S503) The tampering inspection unit 131 acquires the ith inspection target from the outsourcing information received in step S401.

(Step S504) the tampering inspection unit 131 executes the smart contract stored in the storage unit 11, on the ith inspection target acquired in step S503, to acquire information indicating whether or not the ith inspection target has been tampered with.

(Step S505) If the ith inspection target has not been tampered with, processing proceeds to step S506, and if the ith inspection target has been tampered with, processing proceeds to step S507.

(Step S506) The tampering inspection unit 131 substitutes information indicating “not tampered with” into the inspection result. Processing proceeds to step S508.

(Step S507) The tampering inspection unit 131 substitutes information indicating “tampered with” into the inspection result.

(Step S508) The tampering inspection unit 131 accumulates inspection results in a buffer (not shown) in association with the identifier (for example, the partial outsourcing information identifier) of the ith inspection target.

(Step S509) The tampering inspection unit 131 increments the counter i by 1. Processing returns to step S502.

Note that, in the flowchart in FIG. 5, blockchain technology is used to perform a tampering inspection. However, a tampering inspection using the watermarking and time-stamping techniques described above may be performed separately from or in addition to the tampering inspection using blockchain technology.

Next, an example of the determination processing in step S410 will be described with reference to the flowchart in FIG. 6.

(Step S601) The determination unit 134 acquires the outsourcing identifier included in the outsourcing information transmission instruction received in step S409.

(Step S602) The determination unit 134 acquires the outsourcee identifier or the subcontractor identifier included in the outsourcing information transmission instruction received in step S409.

(Step S603) The subject identifier acquisition part 1341 performs natural language processing on the agreement information included in the outsourcing information identified by the outsourcing identifier acquired in step S601 or the agreement information or the subcontract corresponding to the outsourcee identifier or the subcontractor identifier acquired in step S602, to acquire the subject identifier of the subject of the outsourcing of manufacturing to the outsourcee or the subcontractor identified by the outsourcee identifier or the subcontractor identifier acquired in step S602.

(Step S604) The determination part 1342 acquires the outsourcing information identified by the outsourcing identifier acquired in step S601, from the outsourcing information storage unit 111.

(Step S605) The determination part 1342 substitutes 1 for the counter i.

(Step S606) The determination part 1342 judges whether or not the ith piece of partial outsourcing information is present in the outsourcing information acquired in step S604. If the ith piece of partial outsourcing information is present, processing proceeds to step S607, and if the ith piece of partial outsourcing information is not present, processing returns to higher level processing.

(Step S607) The determination part 1342 attempts to acquire the specification information corresponding to the ith piece of partial outsourcing information from the outsourcing information storage unit 111. Note that specification information is, for example, a subject identifier, an outsourcee identifier, or a subcontractor identifier.

(Step S608) The determination part 1342 judges whether or not specification information has successfully been acquired in step S607. If specification information has successfully been acquired, processing proceeds to step S609, and if not, processing proceeds to step S610.

(Step S609) The determination part 1342 judges whether or not the specification information acquired in step S608 corresponds (for example, matches) the subject identifier acquired in step S603, or the outsourcee identifier or the subcontractor identifier acquired in step S602. Note that the partial outsourcing information for the specification information associated therewith is the partial outsourcing information determined in the present determination processing as being disclosable.

(Step S610) The determination part 1342 accumulates the partial outsourcing information identifier that identifies the ith piece of partial outsourcing information in a buffer (not shown). Note that the partial outsourcing information that is not associated with the specification information is the partial outsourcing information that has been determined in the present determination processing as the partial outsourcing information being disclosable.

(Step S611) The determination unit 134 increments the counter i by 1. Processing returns to step S606.

Next, an example of the permission acquisition processing in step S411 will be described with reference to the flowchart in FIG. 7.

(Step S701) The processing unit 13 acquires one or more partial outsourcing information identifiers accumulated by the determination part 1342 in a buffer (not shown) in step S610.

(Step S702) Using one or more partial outsourcing information identifiers, the processing unit 13 forms inquiry information that is used to inquire of the outsourcer identified by the outsourcer identifier to judge whether or not the one or more pieces of partial outsourcing information respectively identified by the one or more partial outsourcing information identifiers can be disclosed to the outsourcee or outsourcee candidates or the like. Inquiry information is, for example, screen information that is used to form a screen for selecting one or more partial outsourcing information identifiers from among one or more partial outsourcing information identifiers. It is preferable that inquiry information includes the identifiers (the company name or the like) of the outsourcee or outsourcee candidates or the subcontractor or subcontractor candidates.

(Step S703) The inquiry transmission unit 142 transmits the inquiry information formed in step S702 to the first terminal 2 of the outsourcer identified by the outsourcer identifier.

(Step S704) In response to the inquiry information being transmitted, the permission information reception unit 123 judges whether or not permission information that can be used to specify the partial outsourcing information that is to be permitted to be disclosed has been received. If permission information has been received, processing returns to higher-level processing, and if permission information has not been received, processing returns to step S704.

Note that, in the flowchart in FIG. 7, the permission information input by the outsourcer may be stored in advance in the storage unit 11 in association with the outsourcing information identifier. In such a case, the processing unit 13 need only acquire the permission information associated with the outsourcing information identifier from the storage unit 11.

In addition, the permission information input by the outsourcer may be stored in the storage unit 11 in association with the outsourcing information identifier and the user identifier. In such a case, the processing unit 13 need only acquire the permission information associated with the outsourcing information identifier and the user identifier from the storage unit 11. Note that the user identifier is an outsourcee identifier or a subcontractor identifier. In addition, in such a case, it is possible to disclose appropriate partial outsourcing information depending on the user (the outsourcee or the subcontractor).

Next, an example of the risk information acquisition processing in step S413 will be described with reference to the flowchart in FIG. 8.

(Step S801) The risk information acquisition unit 133 judges whether or not the risk information to be acquired is risk information regarding the outsourcee. If the risk information is risk information regarding the outsourcee, processing proceeds to step S802, and if the risk information is not risk information regarding the outsourcee, processing proceeds to step S806. Note that the risk information acquisition unit 133 judges whether or not the user identifier included in the received outsourcing information transmission instruction or risk information transmission instruction is an outsourcee identifier or a subcontractor identifier to judge whether or not the risk information to be acquired is risk information regarding the outsourcee.

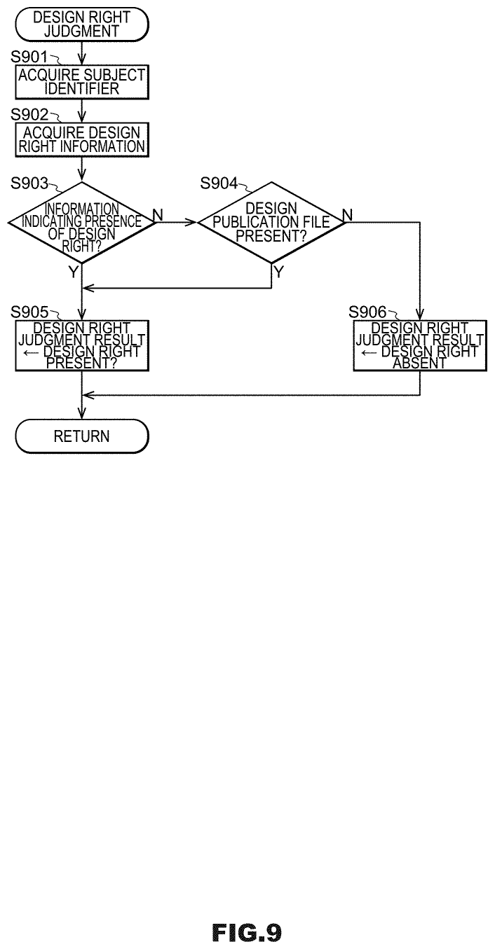

(Step S802) The design right judgment part 1331 performs design right judgment processing, which is judgment regarding whether or not the outsourcer owns the design right for the subject of outsourcing, on the outsourcing information to be inspected. An example of design right judgment processing will be described with reference to the flowchart in FIG. 9.

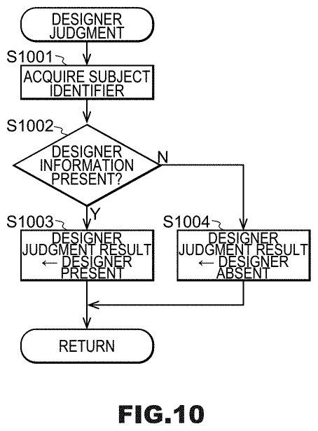

(Step S803) The designer judgment part 1332 judges whether or not designer information is included in the outsourcing information that is to be inspected. An example of such designer judgment processing will be described with reference to the flowchart in FIG. 10.

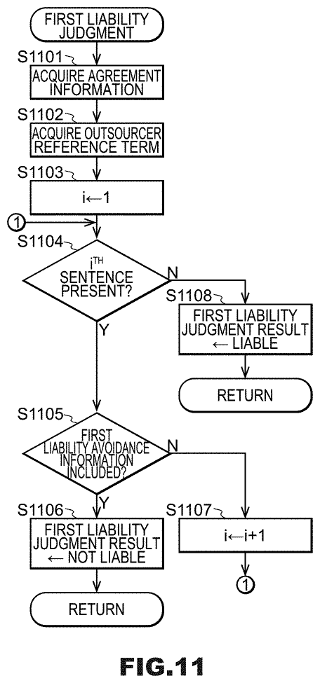

(Step S804) The first liability judgment part 1333 inspects the agreement information included in the outsourcing information that is to be inspected to judge whether or not the agreement information includes first liability avoidance information. An example of such first liability judgment processing will be described with reference to the flowchart in FIG. 11.

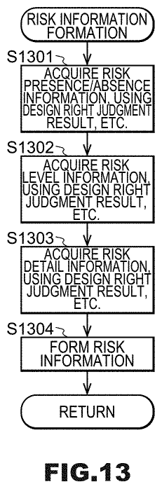

(Step S805) The risk information acquisition part 1335 forms risk information, using the judgment results acquired in steps S802 to S804. Processing returns to higher-level processing. An example of risk information forming processing will be described with reference to the flowchart in FIG. 13.

(Step S806) The risk information acquisition unit 133 judges whether or not the risk information to be acquired is risk information regarding the subcontractor. If the risk information is risk information regarding the subcontractor, processing proceeds to step S807, and if the risk information is not risk information regarding the subcontractor, processing proceeds to step S811. Note that the risk information acquisition unit 133 judges whether or not the user identifier included in the received outsourcing information transmission instruction or risk information transmission instruction is an outsourcee identifier or a subcontractor identifier to judge whether or not the risk information to be acquired is risk information regarding the subcontractor.

(Step S807) The design right judgment part 1331 performs design right judgment processing, which is judgment regarding whether or not the outsourcer owns the design right for the subject of outsourcing, on the outsourcing information to be inspected. An example of design right judgment processing will be described with reference to the flowchart in FIG. 9.

(Step S808) The designer judgment part 1332 judges whether or not designer information is included in the outsourcing information that is to be inspected. An example of such designer judgment processing will be described with reference to the flowchart in FIG. 10.

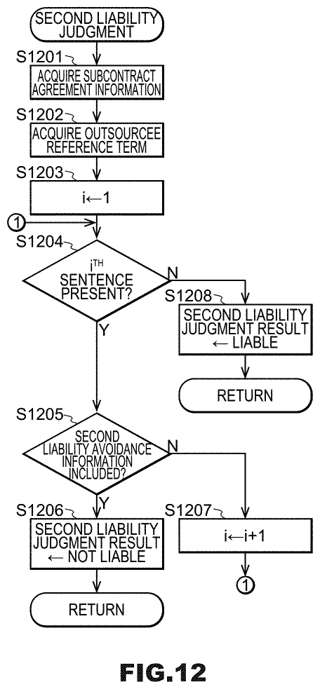

(Step S809) The second liability judgment part 1334 inspects the subcontract agreement information corresponding to the outsourcing information that is to be inspected to judge whether or not the subcontract agreement information includes second liability avoidance information. An example of such second liability judgment processing will be described with reference to the flowchart in FIG. 12.

(Step S810) The risk information acquisition part 1335 forms risk information, using the judgment results acquired in steps S807 to S809. Processing returns to higher-level processing. An example of risk information forming processing will be described with reference to the flowchart in FIG. 13.

(Step S811) The risk information acquisition part 1335 substitutes information indicating an error into a variable “risk information”. Processing returns to higher-level processing.

Next, an example of the design right judgment processing in step S802 will be described with reference to the flowchart in FIG. 9.

(Step S901) The design right judgment part 1331 acquires the subject identifier. Note that the method through which the design right judgment part 1331 acquires the subject identifier may be the same as the method through which the subject identifier acquisition part 1341 acquires the subject identifier.

(Step S902) The design right judgment part 1331 acquires the design right information corresponding to the subject identifier acquired in step S901, from the outsourcing information storage unit 111.

(Step S903) The design right judgment part 1331 judges whether or not the design right information acquired in step S902 is information indicating the presence of the design right (for example, information that matches “Design Registration No. [0-9]+”). If the design right information is information indicating the presence of the design right, the processing proceeds to step S905, and if the design right information is not information indicating the presence of the design right, processing proceeds to step S904.

(Step S904) The design right judgment part 1331 judges whether or not a design publication file corresponding to the subject identifier acquired in step S901 is present in the outsourcing information storage unit 111. If a design publication file is present, processing proceeds to step S905, and if not, processing proceeds to step S906.

(Step S905) The design right judgment part 1331 substitutes information indicating “design right present” into a variable “design right judgment result”. Processing returns to higher-level processing.

(Step S906) The design right judgment part 1331 substitutes information indicating “design right absent” into the variable “design right judgment result”. Processing returns to higher-level processing.

Next, an example of the designer judgment processing in step S803 will be described with reference to the flowchart in FIG. 10.

(Step S1001) The designer judgment part 1332 acquires the subject identifier. Note that the method through which the designer judgment part 1332 acquires the subject identifier may be the same as the method through which the subject identifier acquisition part 1341 acquires the subject identifier.

(Step S1002) The designer judgment part 1332 judges whether or not the designer information corresponding to the subject identifier acquired in step S1001 is present in the outsourcing information storage unit 111. If the designer information is present, the processing proceeds to step S1003, and if the designer information is not present, the processing proceeds to step S1004.

(Step S1003) The designer judgment part 1332 substitutes information indicating “designer present” into a variable “designer judgment result”. Processing returns to higher-level processing.

(Step S1004) The designer judgment part 1332 substitutes information indicating “designer present” into the variable “designer judgment result”. Processing returns to higher-level processing.

Next, an example of the first liability judgment processing in step S804 will be described with reference to the flowchart in FIG. 11.

(Step S1101) The first liability judgment part 1333 acquires the agreement information to be inspected.

(Step S1102) The first liability judgment part 1333 analyzes the agreement information acquired in step S1101 to acquire the reference term directed to the outsourcer (typically, “First Party” or “Second Party”). Note that the reference term directed to the outsourcer may have been determined as “First Party”. [0263] (Step S1103) The first liability judgment part 1333 substitutes 1 for the counter i.

(Step S1104) The first liability judgment part 1333 judges whether or not the ith sentence is present in the agreement information acquired in step S1101. If the ith sentence is present, processing proceeds to step S1105, and if the ith sentence is not present, processing proceeds to step S1108.

(Step S1105) The first liability judgment part 1333 judges whether or not first liability avoidance information is included in the ith sentence, using the reference term directed to the outsourcer acquired in step S1102. If first liability avoidance information is included, processing proceeds to step S1106, and if first liability avoidance information is not included, processing proceeds to step S1107.

(Step S1106) The first liability judgment part 1333 substitutes information indicating “not liable” into a variable “first liability judgement result”. Processing returns to higher-level processing. [0267] (Step S1107) The first liability judgment part 1333 increments the counter i by 1. Processing returns to step S1104.

(Step S1108) The first liability judgment part 1333 substitutes information indicating “with liability” into the variable “first liability judgement result”. Processing returns to higher-level processing.

Next, an example of the second liability judgment processing in step

S809 will be described with reference to the flowchart in FIG. 12.

(Step S1201) The second liability judgment part 1334 acquires the subcontract agreement information to be inspected.

(Step S1202) The second liability judgment part 1334 analyzes the subcontract agreement information acquired in step S1201 to acquire the reference term directed to the outsourcee (typically, “First Party” or “Second Party”). Note that the reference term directed to the outsourcee of the subcontract may have been determined in advance as “First Party”.

(Step S1203) The second liability judgment part 1334 substitutes 1 for the counter i.

(Step S1204) The second liability judgment part 1334 judges whether or not the ith sentence is present in the subcontract agreement information acquired in step S1201. If the ith sentence is present, processing proceeds to step S1205, and if the ith sentence is not present, processing proceeds to step S1208.

(Step S1205) The second liability judgment part 1334 judges whether or not second liability avoidance information is included in the ith sentence, using the reference term directed to the outsourcee acquired in step S1202. If second liability avoidance information is included, processing proceeds to step S1206, and if second liability avoidance information is not included, processing proceeds to step S1207.

(Step S1206) The second liability judgment part 1334 substitutes information indicating “not liable” into a variable “second liability judgement result”. Processing returns to higher-level processing.

(Step S1207) The second liability judgment part 1334 increments the counter i by 1. Processing returns to step S1204.

(Step S1208) The second liability judgment part 1334 substitutes information indicating “liable” into the variable “second liability judgement result”. Processing returns to higher-level processing.

Next, an example of the risk information forming processing in steps S805 and S811 will be described with reference to the flowchart in FIG. 13.

(Step S1301) The risk information acquisition part 1335 acquires risk presence/absence information, using the design right judgment result and so on that have been acquired. The design right judgment result and so on are, for example, the design right judgment result, the designer judgment result, and the first liability judgement result. The design right judgment result and so on are, for example, the design right judgment result, the designer judgment result, and the second liability judgement result.

(Step S1302) The risk information acquisition part 1335 acquires risk level information, using the design right judgment result and so on that have been acquired.

(Step S1303) The risk information acquisition part 1335 acquires risk detail information, using the design right judgment result and so on that have been acquired.

(Step S1304) The risk information acquisition part 1335 forms risk information, using the risk presence/absence information acquired in step S1301, the risk level information acquired in step S1302, and the risk detail information acquired in step S1303. Processing returns to higher-level processing. Note that the risk information includes one or more kinds of information of risk presence/absence information, risk level information, and risk detail information.

Next, an example of the subcontract prohibition judgment processing in step S420 will be described with reference to the flowchart in FIG. 14.

(Step S1401) The subcontract prohibition judgment part 1351 acquires the outsourcing identifier corresponding to the received information regarding a subcontract.

(Step S1402) The subcontract prohibition judgment part 1351 acquires the agreement information paired with the outsourcing identifier acquired in step S1401.

(Step S1403) The subcontract prohibition judgment part 1351 substitutes 1 for the counter i.

(Step S1404) The subcontract prohibition judgment part 1351 judges whether or not the ith sentence is present in the agreement information acquired in step S1402. If the ith sentence is present, processing proceeds to step S1405, and if the ith sentence is not present, processing proceeds to step S1408.

(Step S1405) The subcontract prohibition judgment part 1351 judges whether or not the ith sentence includes subcontract prohibition information. If the ith sentence includes subcontract prohibition information, processing proceeds to step S1406, and if the ith sentence does not include subcontract prohibition information, processing proceeds to step S1407.

(Step S1406) The subcontract prohibition judgment part 1351 substitutes information indicating “prohibited” to a variable “subcontract prohibition judgment result”. Processing returns to higher-level processing.

(Step S1407) The subcontract prohibition judgment part 1351 increments the counter i by 1. Processing returns to step S1404.

(Step S1408) The subcontract prohibition judgment part 1351 substitutes information indicating “not prohibited” to the variable “subcontract prohibition judgment result”. Processing returns to higher-level processing.

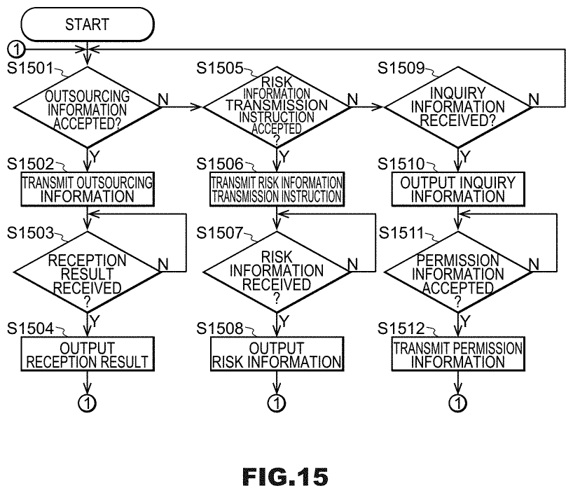

Next, examples of operations of a first terminal 2 will be described with reference to the flowchart in FIG. 15.

(Step S1501) The first acceptance unit 22 judges whether or not outsourcing information has been accepted. If outsourcing information has been accepted, processing proceeds to step S1502, and if outsourcing information has not been accepted, processing proceeds to step S1505.

(Step S1502) The first processing unit 23 converts the outsourcing information accepted in step S1501 into information that has a structure suitable for transmission. The first transmission unit 24 transmits information that includes the outsourcing information to the outsourcing management apparatus 1. Note that the information to be transmitted includes the outsourcing information, and the outsourcer identifier in the first storage unit 21.

(Step S1503) The first reception unit 25 judges whether or not the reception result corresponding to the transmission of the outsourcing information has been received from the outsourcing management apparatus 1. If the reception result has been received, processing proceeds to step S1504, and if the reception result has not been received, processing returns to step S1503.

(Step S1504) The first processing unit 23 converts the reception result received in step S1503 into information that has a structure suitable for output. The first output unit 26 outputs the reception result. Processing returns to step S1501.

(Step S1505) The first acceptance unit 22 judges whether or not a risk information transmission instruction has been accepted. If a risk information transmission instruction has been accepted, processing proceeds to step S1506, and if a risk information transmission instruction has not been accepted, processing proceeds to step S1509.

(Step S1506) The first processing unit 23 converts the risk information transmission instruction accepted in step S1505 to information that has a structure suitable for transmission. The first transmission unit 24 transmits the risk information transmission instruction to the outsourcing management apparatus 1. Note that the risk information transmission instruction to be transmitted includes, for example, the outsourcer identifier in the first storage unit 21.

(Step S1507) The first reception unit 25 judges whether or not risk information has been received from the outsourcing management apparatus 1. If risk information has been received, processing proceeds to step S1508, and if risk information has not been received, processing returns to step S1507.

(Step S1508) The first processing unit 23 converts the risk information received in step S1507 into information that has a structure suitable for output. The first output unit 26 outputs the risk information. Processing returns to step S1501.

(Step S1509) The first reception unit 25 judges whether or not inquiry information has been received from the outsourcing management apparatus 1. If inquiry information has been received, processing proceeds to step S1510, and if inquiry information has not been received, processing returns to step S1501.

(Step S1510) The first processing unit 23 converts the inquiry information received in step S1509 into information that has a structure suitable for output. The first output unit 26 outputs the inquiry information.

(Step S1511) In response to the inquiry information being output, the first acceptance unit 22 judges whether or not permission information has been accepted. If permission information has been accepted, processing proceeds to step S1512, and if permission information has not been accepted, processing proceeds to step S1512.

(Step S1512) The first processing unit 23 converts the permission information accepted in step S1511 into information that has a structure suitable for transmission. The first transmission unit 24 transmits the permission information to the outsourcing management apparatus 1.

Processing returns to step S1501. Note that the permission information to be transmitted includes, for example, the outsourcer identifier in the first storage unit 21.

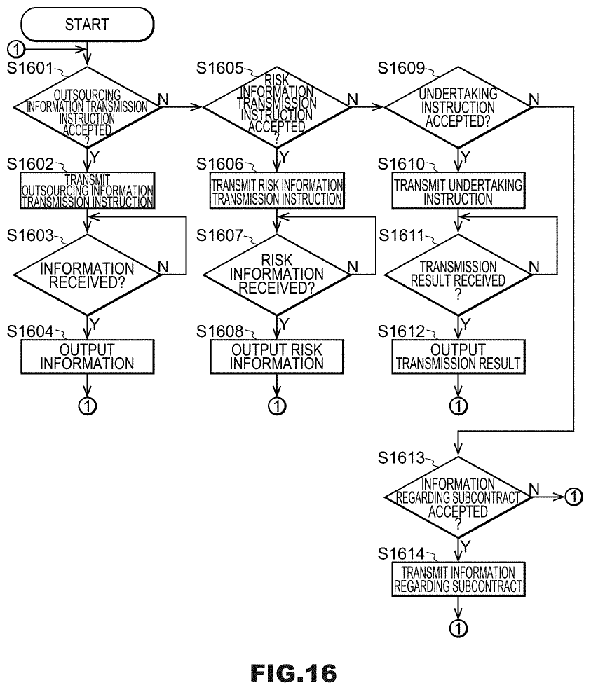

Next, examples of operations of a second terminal 3 will be described with reference to the flowchart in FIG. 16.

(Step S1601) The second acceptance unit 32 judges whether or not an outsourcing information transmission instruction has been accepted. If an outsourcing information transmission instruction has been accepted, processing proceeds to step S1602, and if an outsourcing information transmission instruction has not been accepted, processing proceeds to step S1605.

(Step S1602) The second processing unit 33 converts the outsourcing information transmission instruction accepted in step S1601 into information that has a structure suitable for transmission. The second transmission unit 34 transmits the outsourcing information transmission instruction to the outsourcing management apparatus 1. Note that the outsourcing information transmission instruction to be transmitted includes, for example, the outsourcee identifier in the second storage unit 31.

(Step S1603) The second reception unit 35 judges whether or not information has been received from the outsourcing management apparatus 1. If information has been received, processing proceeds to step S1604, and if information has not been received, processing returns to step S1603. Note that information here is, for example, one or more pieces of partial outsourcing information and risk information. [0309] (Step S1604) The second processing unit 33 converts the information received in step S1603 into information that has a structure suitable for output. The second output unit 36 outputs the information. Processing returns to step S1601.

(Step S1605) The second acceptance unit 32 judges whether or not a risk information transmission instruction has been accepted. If a risk information transmission instruction has been accepted, processing proceeds to step S1606, and if a risk information transmission instruction has not been accepted, processing proceeds to step S1609.

(Step S1606) The second processing unit 33 converts the risk information transmission instruction accepted in step S1605 into information that has a structure suitable for transmission. The second transmission unit 34 transmits the risk information transmission instruction to the outsourcing management apparatus 1. Note that the risk information transmission instruction to be transmitted includes, for example, the outsourcee identifier in the second storage unit 31.

(Step S1607) The second reception unit 35 judges whether or not risk information has been received from the outsourcing management apparatus 1. If risk information has been received, processing proceeds to step S1608, and if risk information has not been received, processing returns to step S1607.

(Step S1608) The second processing unit 33 converts the risk information received in step S1607 into information that has a structure suitable for output. The second output unit 36 outputs the risk information. Processing returns to step S1601.

(Step S1609) The second acceptance unit 32 judges whether or not an undertaking instruction has been accepted. If an undertaking instruction has been accepted, processing proceeds to step S1610, and if an undertaking instruction has not been accepted, processing proceeds to step S1613.

(Step S1610) The second processing unit 33 converts the undertaking instruction accepted in step S1609 into information that has a structure suitable for transmission. The second transmission unit 34 transmits the undertaking instruction to the outsourcing management apparatus 1. Note that the undertaking instruction to be transmitted includes, for example, the outsourcee identifier in the second storage unit 31.

(Step S1611) The second reception unit 35 judges whether or not the transmission result of the undertaking instruction has been received from the outsourcing management apparatus 1. If the transmission result has been received, processing proceeds to step S1612, and if the transmission result has not been received, processing returns to step S1611.

(Step S1612) The second processing unit 33 converts the transmission result received in step S1611 into information that has a structure suitable for output. The second output unit 36 outputs the transmission result. Processing returns to step S1601.

(Step S1613) The second acceptance unit 32 judges whether or not information regarding a subcontract has been accepted. If information regarding a subcontract has been accepted, processing proceeds to step S1614, and if information regarding a subcontract has not been accepted, processing returns to step S1601.

(Step S1614) The second processing unit 33 converts the information regarding a subcontract accepted in step S1613 into information that has a structure suitable for transmission. The second transmission unit 34 transmits the information regarding a subcontract to the outsourcing management apparatus 1. Processing returns to step S1601. Note that the information regarding a subcontract to be transmitted includes, for example, subcontract agreement information, an outsourcee identifier, and a subcontractor identifier.

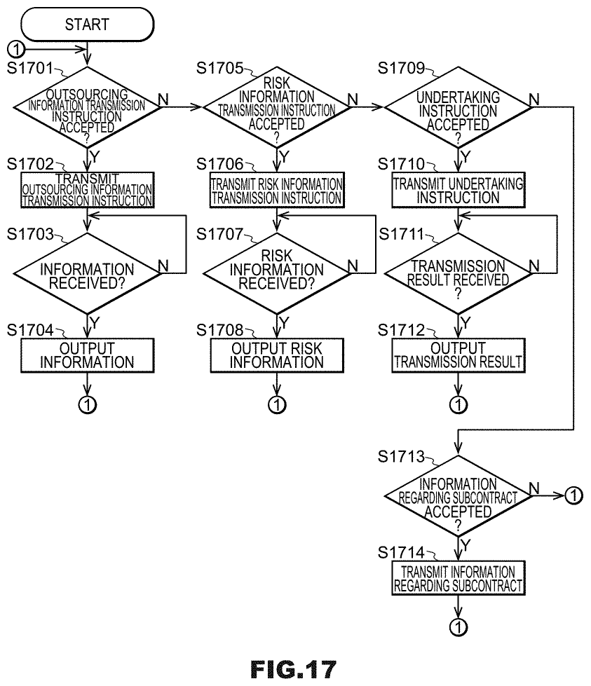

Next, examples of operations of a third terminal 4 will be described with reference to the flowchart in FIG. 17.

(Step S1701) The third acceptance unit 42 judges whether or not an outsourcing information transmission instruction has been accepted. If an outsourcing information transmission instruction has been accepted, processing proceeds to step S1702, and if an outsourcing information transmission instruction has not been accepted, processing proceeds to step S1705.

(Step S1702) The third processing unit 43 converts the outsourcing information transmission instruction accepted in step S1701 into information that has a structure suitable for transmission. The third transmission unit 44 transmits the outsourcing information transmission instruction to the outsourcing management apparatus 1. Note that the outsourcing information transmission instruction to be transmitted includes, for example, the outsourcee identifier in the third storage unit 41.

(Step S1703) The third reception unit 45 judges whether or not information has been received from the outsourcing management apparatus 1. If information has been received, processing proceeds to step S1704, and if information has not been received, processing returns to step S1703. Note that information here is, for example, one or more pieces of partial outsourcing information and risk information.

(Step S1704) The third processing unit 43 converts the information received in step S1703 into information that has a structure suitable for output. The third output unit 46 outputs the information. Processing returns to step S1701.

(Step S1705) The third acceptance unit 42 judges whether or not a risk information transmission instruction has been accepted. If a risk information transmission instruction has been accepted, processing proceeds to step S1706, and if a risk information transmission instruction has not been accepted, processing proceeds to step S1709.

(Step S1706) The third processing unit 43 converts the risk information transmission instruction accepted in step S1705 into information that has a structure suitable for transmission. The third transmission unit 44 transmits the risk information transmission instruction to the outsourcing management apparatus 1. Note that the risk information transmission instruction to be transmitted includes, for example, the outsourcee identifier in the third storage unit 41.

(Step S1707) The third reception unit 45 judges whether or not risk information has been received from the outsourcing management apparatus 1. If risk information has been received, processing proceeds to step S1708, and if risk information has not been received, processing returns to step S1707.

(Step S1708) The third processing unit 43 converts the risk information received in step S1707 into information that has a structure suitable for output. The third output unit 46 outputs the risk information. Processing returns to step S1701.

(Step S1709) The third acceptance unit 42 judges whether or not an undertaking instruction has been accepted. If an undertaking instruction has been accepted, processing proceeds to step S1710, and if an undertaking instruction has not been accepted, processing returns to step S1701.

(Step S1710) The third processing unit 43 converts the undertaking instruction accepted in step S1709 into information that has a structure suitable for transmission. The third transmission unit 44 transmits the undertaking instruction to the outsourcing management apparatus 1. Note that the undertaking instruction to be transmitted includes, for example, the subcontractor identifier in the third storage unit 41.

(Step S1711) The third reception unit 45 judges whether or not the transmission result of the undertaking instruction has been received. If the transmission result has been received, processing proceeds to step S1712, and if the transmission result has not been received, processing returns to step S1711.

(Step S1712) The third processing unit 43 converts the transmission result received in step S1711 into information that has a structure suitable for output. The third output unit 46 outputs the transmission result. Processing returns to step S1701.

(Step S1713) The third acceptance unit 42 judges whether or not information regarding a subcontract has been accepted. If information regarding a subcontract has been accepted, processing proceeds to step S1714, and if information regarding a subcontract has not been accepted, processing returns to step S1701.

(Step S1714) The third processing unit 43 converts the information regarding a subcontract accepted in step S1713 into information that has a structure suitable for transmission. The third transmission unit 44 transmits the information regarding a subcontract to the outsourcing management apparatus 1. Processing returns to step S1701. Note that the information regarding a subcontract to be transmitted includes, for example, subcontract agreement information, an outsourcee identifier, and a subcontractor identifier.

As described above, according to the present invention, it is possible to solve or alleviate various problems that may arise when manufacturing is outsourced and the outsourced manufacturing is undertaken.

In addition, according to the present embodiment, the outsourcee or the like can acquire information regarding the risk in the case of undertaking the outsourced manufacturing.

In addition, according to the present embodiment, the outsourcee or the like can acquire information regarding the risk of infringing a design right in the case of undertaking the outsourced manufacturing.

In addition, according to the present embodiment, the outsourcee or the like can acquire information regarding the risk of infringing a third party's right in the case of undertaking the outsourced manufacturing.

In addition, according to the present embodiment, it is possible to provide appropriate risk information to a subcontractor.

In addition, according to the present embodiment, it is possible to protect the interests of the outsourcer by disclosing only necessary information for the outsourcee to the outsourcee.

In addition, according to the present embodiment, it is possible to disclose appropriate information depending on the trust score of the outsourcee or the subcontractor.

In addition, according to the present embodiment, when information is to be disclosed to the outsourcee, it is possible to protect the interests of the outsourcer more reliably by providing a mechanism that necessitates the permission of the outsourcer.

In addition, according to the present embodiment, it is possible to inspect for tampering with the outsourcing information transmitted by the outsourcer. Therefore, it is easier for the outsourcee to judge whether or not to undertake the outsourced manufacturing.

Furthermore, according to the present embodiment, it is possible to detect prohibition of a subcontract, and perform appropriate processing.

Note that the processing in the present embodiment may be realized using software. This software may be distributed through software downloading or the like. Also, this software may be recorded on a recording medium such as a CD-ROM and distributed. Note that the same applies to the other embodiments in the present description. The software that realizes the outsourcing management apparatus 1 in the present embodiment is the program described below. That is to say, this program is a program for enabling a computer to function as: an outsourcing information reception unit that receives, from a first terminal, outsourcing information regarding outsourcing of manufacturing, in association with an outsourcer identifier that identifies an outsourcer that outsources manufacturing; an outsourcing information accumulation unit that accumulates the outsourcing information received by the outsourcing information reception unit; a risk information acquisition unit that inspects the outsourcing information to acquire risk information regarding the risk in the case of undertaking outsourced manufacturing corresponding to the outsourcing information; and a risk information transmission unit that transmits the risk information acquired by the risk information acquisition unit to a second terminal.

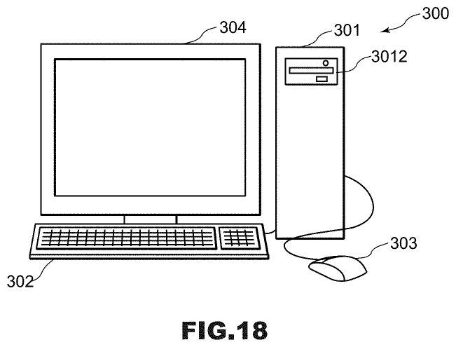

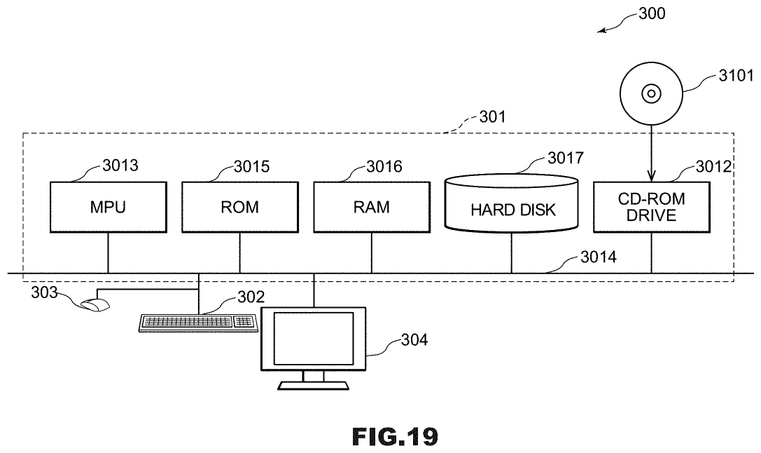

FIG. 18 shows the external appearance of a computer that executes the program described herein to realize the outsourcing management apparatus 1 and so on according to the various embodiments described above. The above-described embodiments can be realized using computer hardware and a computer program that runs thereon. FIG. 18 is an overview diagram for this computer system 300 and FIG. 19 is a block diagram for the system 300.

In FIG. 18, the computer system 300 includes a computer 301 that includes a CD-ROM drive, a keyboard 302, a mouse 303, and a monitor 304.

In FIG. 19, the computer 301 includes, in addition to the CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the drawings, the computer 301 may further include a network card that provides connection to a LAN.

The program that enables the computer system 300 to perform the functions of the outsourcing management apparatus 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third-party program, or the like that enables the computer 301 to perform the functions of the outsourcing management apparatus 1 and so on according to the above-described embodiments. The program need only contain the part of the instruction that calls an appropriate function (module) in a controlled manner to achieve a desired result. How the computer system 300 works is well known and the detailed descriptions thereof will be omitted.

In the above-described program, the step of transmitting information, the step of receiving information, and so on do not include processing performed by hardware, such as processing performed by a modem or an interface card in the step of transmitting (processing that can only be performed by hardware).

There may be a single or multiple computers executing the above-described program. That is to say, centralized processing or distributed processing may be performed.

Also, as a matter of course, in each of the above-described embodiments, two or more communication means that are present in one apparatus may be physically realized using one medium.

Also, in the above-described embodiments, each kind of processing may be realized as centralized processing that is performed by a single apparatus, or distributed processing that is performed by multiple apparatuses.

As a matter of course, the present invention is not limited to the above-described embodiments, and various changes are possible, and such variations are also included within the scope of the present invention.

### INDUSTRIAL APPLICABILITY

As described above, the outsourcing management apparatus according to the present invention achieves the effect of solving or alleviating various problems that may arise when manufacturing is outsourced and the outsourced manufacturing is undertaken, and is useful as an outsourcing management apparatus or the like that manages the outsourcing of manufacturing.

1. An outsourcing management apparatus comprising:
an outsourcing information reception unit that receives, from a first terminal, outsourcing information regarding outsourcing of manufacturing, in association with an outsourcer identifier that identifies an outsourcer that outsources manufacturing;
an outsourcing information accumulation unit that accumulates the outsourcing information received by the outsourcing information reception unit;
a risk information acquisition unit that inspects the outsourcing information to acquire risk information regarding the risk in the case of undertaking outsourced manufacturing corresponding to the outsourcing information; and
a risk information transmission unit that transmits the risk information acquired by the risk information acquisition unit to a second terminal.

2. The outsourcing management apparatus according to claim 1,
wherein the risk information acquisition unit inspects the outsourcing information to acquire risk information regarding the possibility of infringing a third party's design right when outsourcing of manufacturing corresponding to the outsourcing information is to be undertaken.

3. The outsourcing management apparatus according to claim 2,
wherein the outsourcing information includes design right information regarding a design right owned by the outsourcer, or designer information regarding a designer who designed a subject of the outsourcing of manufacturing, and
the risk information acquisition unit inspects the outsourcing information, and if the risk information acquisition unit judges that the design right information included in the outsourcing information is information indicating that the outsourcer owns a design right for the subject of the outsourcing of manufacturing, or if the risk information acquisition unit judges that outsourcing information includes designer information, the risk information acquisition unit acquires risk information indicating a risk level that is low enough to satisfy a predetermined condition.

4. The outsourcing management apparatus according to claim 1,
wherein the outsourcing information includes agreement information regarding an outsourcing agreement,
the agreement information can include first liability avoidance information indicating that the outsourcer is liable if the subject of the outsourcing of manufacturing infringes a third party's right, and
if the agreement information included in the outsourcing information includes the first liability avoidance information, the risk information acquisition unit acquires risk information indicating a risk level that is low enough to satisfy a predetermined condition.

5. The outsourcing management apparatus according to claim 4,
wherein the risk information acquisition unit includes:
a first liability judgment part that inspects the agreement information included in the outsourcing information to judge whether or not the agreement information includes the first liability avoidance information; and
a risk information acquisition part that, if the first liability judgment part judges that the agreement information includes the first liability avoidance information, acquires risk information indicating a risk level that is low enough to satisfy a predetermined condition.

6. The outsourcing management apparatus according to claim 4,
wherein subcontract agreement information that is information regarding an agreement corresponding to the outsourcing information and is information regarding a subcontract agreement between the outsourcee and a subcontractor is associated with the outsourcing information,
the subcontract agreement information can include second liability avoidance information indicating that the outsourcee is liable if infringement of a third party's right occurs, and
the risk information acquisition unit includes:
a second liability judgment part that inspects the subcontract agreement information corresponding to the outsourcing information to judge whether or not the subcontract agreement information includes the second liability avoidance information; and
a risk information acquisition part that, if the second liability judgment part judges that the subcontract agreement information includes the second liability avoidance information, acquires risk information that is risk information for the subcontractor and indicates a risk level that is low enough to satisfy a predetermined condition.

7. The outsourcing management apparatus according to claim 1,
wherein the outsourcing information includes two or more pieces of partial outsourcing information each constituting a part of the outsourcing information,
one or more pieces of partial outsourcing information of the two or more pieces of partial outsourcing information are associated with specification information that specifies a subject of the outsourcing of manufacturing, and
the outsourcing management apparatus further comprises:
an instruction reception unit that receives, in association with an outsourcee identifier that identifies an outsourcee that is a user, or a subcontractor identifier that identifies a subcontractor that is a user, an outsourcing information transmission instruction that is an instruction to transmit outsourcing information, from a second terminal of the outsourcee or a third terminal of the subcontractor;
a determination unit that determines one or more pieces of partial outsourcing information corresponding to the subject of the outsourcing of manufacturing to the user identified by the outsourcee identifier or the subcontractor identifier corresponding to the outsourcing information transmission instruction received by the instruction reception unit, using specification information that is associated with the one or more pieces of partial outsourcing information; and
an outsourcing information transmission unit that transmits the one or more pieces of partial outsourcing information determined by the determination unit, to the second terminal or the third terminal.

8. The outsourcing management apparatus according to claim 7,
wherein the specification information includes a subject identifier that identifies the subject of the outsourcing of manufacturing,
the outsourcing information includes agreement information regarding an outsourcing agreement, and
the determination unit includes:
a subject identifier acquisition part that inspects the agreement information to acquire the subject identifier; and
a determination part that determines one or more pieces of partial outsourcing information that include one or more pieces of partial outsourcing information that are paired with the subject identifier acquired by the subject identifier acquisition part.

9. The outsourcing management apparatus according to claim 7, further comprising
an outsourcee information storage unit that stores one or more pieces of outsourcee information that each include an outsourcee identifier that identifies an outsourcee, and a trust score that indicates a degree of trustworthiness of the outsourcee, or one or more pieces of subcontractor information that each include a subcontractor identifier that identifies a subcontractor, and a trust score that indicates a degree of trustworthiness of the subcontractor,
wherein the determination unit uses the trust score that is paired with the outsourcee identifier or the subcontractor identifier, to determine the one or more pieces of partial outsourcing information.

10. The outsourcing management apparatus according to claim 7, further comprising
a permission information reception unit that receives, from the first terminal, permission information indicating that the one or more pieces of partial outsourcing information determined by the determination unit is permitted to be transmitted to the second terminal or the third terminal,
wherein the outsourcing information transmission unit transmits only one or more pieces of partial outsourcing information corresponding to the permission information received by the permission information reception unit, to the second terminal.

11. The outsourcing management apparatus according to claim 1, further comprising:
a tampering inspection unit that inspects for tampering with the outsourcing information received by the outsourcing information reception unit; and
a tampering information output unit that outputs tampering information regarding tampering if the result of the inspection by the tampering inspection unit indicates that the outsourcing information has been tampered with.

12. The outsourcing management apparatus according to claim 1,
wherein the outsourcing information includes agreement information regarding an outsourcing agreement, and
the outsourcing management apparatus further comprises a subcontract prohibition processing unit that judges whether or not subcontract prohibition information that prohibits a subcontract is included in the agreement information, and if the subcontract prohibition processing unit judges that the subcontract prohibition information is included therein, the subcontract prohibition processing unit performs subcontract prohibition processing to prohibit a subcontract.

13. An outsourcing management method that is realized using an outsourcing information reception unit, an outsourcing information accumulation unit, a risk information acquisition unit, and a risk information transmission unit, the outsourcing management method comprising:
an outsourcing information reception step in which the outsourcing information reception unit receives outsourcing information regarding outsourcing of manufacturing from a first terminal, in association with an outsourcer identifier that identifies an outsourcer that outsources manufacturing;
an outsourcing information accumulation step in which the outsourcing information accumulation unit accumulates the outsourcing information received in the outsourcing information reception step;
a risk information acquisition step in which the risk information acquisition unit inspects the outsourcing information to acquire risk information regarding the risk in the case of undertaking outsourced manufacturing corresponding to the outsourcing information; and
a risk information transmission step in which the risk information transmission unit transmits the risk information acquired in the risk information acquisition step, to a second terminal.

14. A recording medium having recorded thereon program for enabling a computer to function as:
an outsourcing information reception unit that receives, from a first terminal, outsourcing information regarding outsourcing of manufacturing, in association with an outsourcer identifier that identifies an outsourcer that outsources manufacturing;
an outsourcing information accumulation unit that accumulates the outsourcing information received by the outsourcing information reception unit;
a risk information acquisition unit that inspects the outsourcing information to acquire risk information regarding the risk in the case of undertaking outsourced manufacturing corresponding to the outsourcing information; and
a risk information transmission unit that transmits the risk information acquired by the risk information acquisition unit to a second terminal.
